(19) United States
(12) Patent Application Publication
(10) Pub. No.: US 2013/0073478 A1
(43) Pub. Date: Mar. 21, 2013

(54) METHODS FOR VENDOR SCORING AND GENERATION OF REQUESTS FOR PROPOSALS AND REPORTS FOR INVESTMENT PRODUCTS

(71) Applicants: Jane ABOYOUN, Brooklyn, NY (US); Philip Herzog, New York, NY (US); Kevin Ng, New York, NY (US); Anibal Soto, Forest Hills, NY (US); Marie Strolin, Trumbull, CT (US); Christopher Yeomans, New York, NY (US)

(72) Inventors: Jane ABOYOUN, Brooklyn, NY (US); Philip Herzog, New York, NY (US); Kevin Ng, New York, NY (US); Anibal Soto, Forest Hills, NY (US); Marie Strolin, Trumbull, CT (US); Christopher Yeomans, New York, NY (US)

(21) Appl. No.: 13/235,164

(22) Filed: Sep. 16, 2011

(51) Int. Cl. G06Q 40/06

(52) U.S. Cl. 705/36 R

(57) ABSTRACT

Electronic or computer-implemented systems and methods for allowing an investment advisor or user to evaluate one or more financial products offered by one or more providers of financial products, involving electronic configuration of a set of required and a set of preferred questions and corresponding appropriate answers for each of the questions in these sets, electronic configuration of weights for each of the questions in the set of preferred questions, electronically provided responses to at least some of the questions, electronic comparison of the appropriate answers and the responses, electronic calculation of preferred, required and combined scores, and electronic presentation of the combined scores to the investment advisor or user. Electronic or computer-implemented systems and methods for the generation of requests for proposals and reports based upon the scores obtained.

### FIELD OF THE INVENTION

The present invention relates in general to the electronic scoring of financial products and their providers, and the electronic generation of requests for proposals and reports.

### BACKGROUND OF THE INVENTION

Investment advisors have an enormous number of financial products to choose from when advising their clients, and there are a host of variables that a prudent investment advisor would like to consider. However, historically, doing so, and keeping records of this process, have been exceedingly time-consuming. Previously, electronic systems and methods have been available to assist advisors in helping their clients choose amongst various financial products offered by various providers and for record-keeping. Prior systems attempted to match advisors with products which best fit their client's needs, but gave the investment advisor limited freedom in customizing the way in which multiple financial products would be considered and weighed against each other, in the way in which the many inquiries involved could be presented to clients or the way in which requests for proposals from investment providers could be generated. Grading software exists in academics (for example, Louisiana State University's “Moodle” system), but it is poorly adapted for use by financial advisors to evaluate financial products. Accordingly, there exists a need for new and improved methods for the electronic scoring of financial products and their providers, and the electronic generation of requests for proposals and reports.

### SUMMARY OF THE INVENTION

The present invention provides computerized methods for customized calculation of scores for financial products and for generating requests for proposals from providers of financial products. In one embodiment, the investment advisor electronically configures a set of required questions and a set of preferred questions, along with appropriate answers to both of these sets of questions and weights for the preferred questions. One or more investment providers electronically provide responses to at least some of these required and preferred questions. A system electronically compares the investment advisor's appropriate answers and the investment provider's responses to determine whether they match. A required question score for the financial products is calculated based at least in part on the fraction or proportion of the members of the set of required questions for which the advisor's appropriate answer matched the provider's response. A preferred question score for the financial products is calculated based at least in part on the specified weights for the individual preferred questions and whether the appropriate answer matched the response for these individual preferred questions. A combined score is calculated based on a weighted average of the required question score and the preferred question score, and presented to the investment advisor.

Embodiments of the methods also electronically generate and track, on behalf of the advisor, customizable requests for proposal (RFPs) that are sent to, and responded to by, providers. These RFPs allow the advisor to obtain additional information about the financial products to assist in advising the advisor's client. The RFPs may optionally be used to request information that is used in calculating the combined score.

Embodiments of the methods also electronically generate customizable reports which the advisor may use to inform the advisor's client of its investment options, or may use as a record of compliance with regulations or with the advisor's duty to fully investigate the client's investment options.

Additionally, embodiments of the methods allow administrators from an organization of which the investment advisor is a part to apply constraints to the investment advisor's selection of questions and investment providers. Such constraints may be selectively applied depending on whether an indication is received that the investment advisor is acting in a consulting capacity.

### BRIEF DESCRIPTION OF THE DRAWINGS

Further features and advantages of the invention may be understood by reviewing the following detailed description of the preferred embodiments of the invention taken together with the attached drawings, in which:

FIGS. 1-1C show a variety of embodiments of computer systems having score computing parts, RFP generating parts, and reporting generating parts, which computer systems may be used to carry out the method of the present invention;

FIG. 2 shows a further example computer system which may be used to carry out the methods of the present invention;

FIG. 3 shows yet another example computer system which may also be used to carry out the methods of the present invention;

FIG. 4 shows a flow diagram of an embodiment of the present invention; and

FIGS. 5-27 show screenshots of a user interface according to embodiments of the present invention.

FIGS. 28A-28M show a preview of a sample report generated according to embodiments of the present invention.

### DETAILED DESCRIPTION OF THE PREFERRED EMBODIMENTS

The present invention is directed to a tool to assist financial investment advisors in selecting appropriate financial products for their clients, which can be, for example, individual investors, corporations, or organizations such as unions. The tool allows the financial advisor to communicate with the client to gather data about the client's investment needs. The tool then surveys financial providers who wish to participate to determine which offers financial products which best suit the client's needs.

Clients often require assistance from investment advisors in determining appropriate financial products that fit their various needs. For example, a client may need to choose investments for a retirement program such as a 401(k), or choose a mutual fund, or choose other financial products on behalf of itself or members of its organization. It may have particular requirements such as automatic enrollment in the program, availability of program materials in Spanish, or the availability of quarterly reports online. Some of these requirements may be absolutely necessary for the client, while others may simply be important to various degrees. For example, automatic enrollment may be absolutely necessary to the client, while the availability of program materials in Spanish is twice as important to the client as the availability of quarterly reports online. Meanwhile, a host of financial products having a variety of features are offered by a great number of investment providers.

Embodiments of the inventive methods allow an investment advisor to electronically obtain a customized and quantified assessment of multiple financial products that takes into consideration not only a client's requirements, but also the relative importance of those requirements. Embodiments of the inventive methods allow the investment advisor to electronically generate and submit RFPs to investment providers and thereby obtain additional information about the financial product and/or information which is used in the quantified assessment. Embodiments of the inventive methods also allow the investment advisor to obtain customizable reports which may be used to advise clients of the relative strengths of their financial product options, or to show compliance with regulations or the advisor's duty to its client.

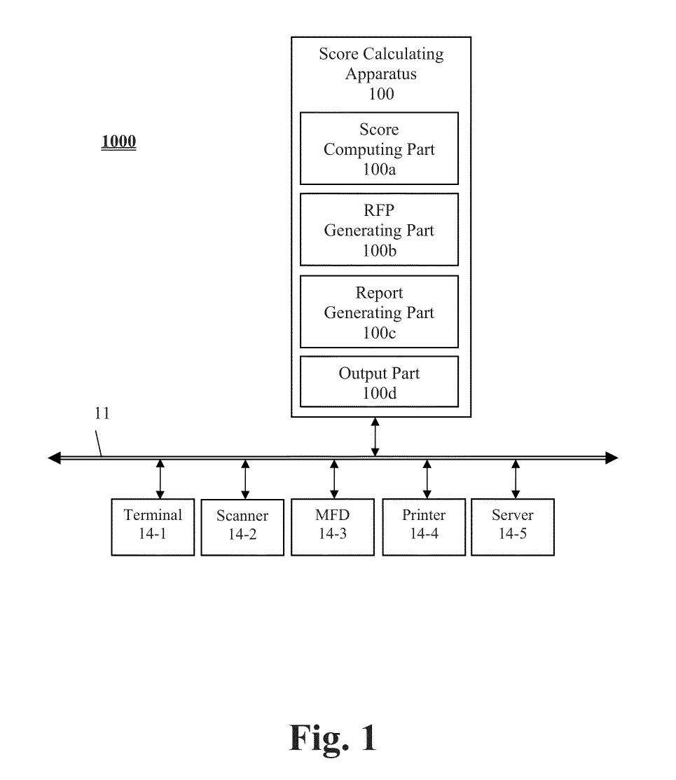

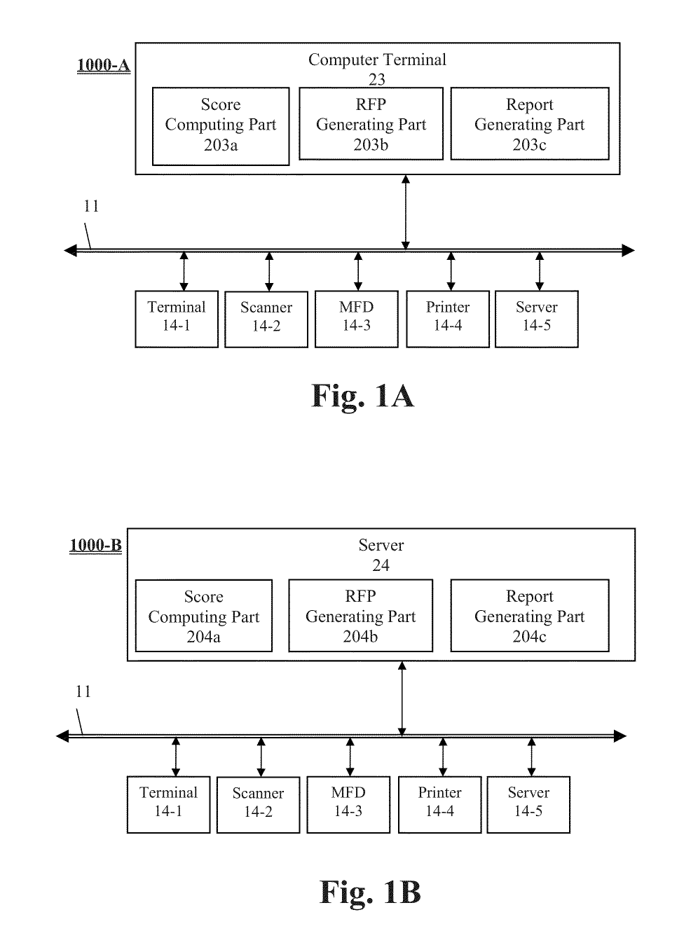

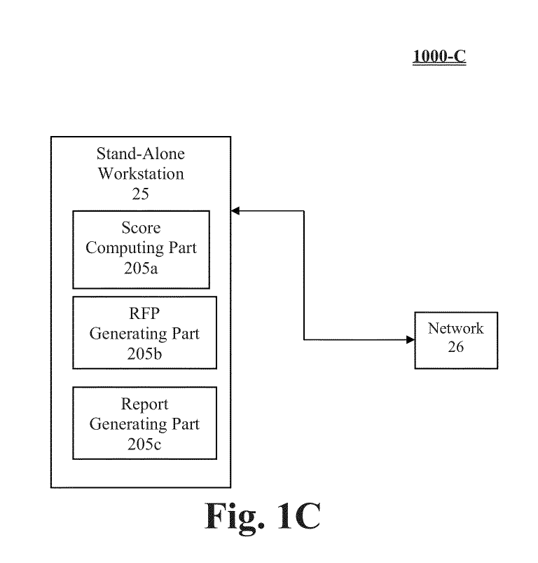

FIG. 1 includes one score calculating apparatus 100 with a score computing part 100a, RFP generating part 100b, report generating part 100c and output part 100d, as well as five other network devices 14-1 through 14-5 connected to a network 11. The network 11 can include one or more of a secure intranet or extranet local area network, a wide area network (WAN), any type of network that allows secure access, or a combination thereof. Further, other secure communications links (such as a virtual private network, a wireless link) may be used as well as the network connections. In addition, the score calculating apparatus 100 may be connected to a network that employs TCP/IP (Transmission Control Protocol/Internet Protocol), but other protocols such as SNMP (Simple Network Management Protocol) and HTTP (Hypertext Transfer Protocol) can also be used. How devices can connect to and communicate over the networks is well-known in the art and is discussed for example, in “How Networks Work”, by Frank J. Dealer, Jr. and Les Freed (Que Corporation 2000) and “How Computers Work”, by Ron White, (Que Corporation 1999), the entire contents of each of which are incorporated herein by reference.

It should be appreciated that such numbers and types of other network devices, terminals and apparatuses are arbitrary and are selected as an example in order to facilitate discussion, and that the subject matter of this disclosure can be implemented in a system including one or more systems, servers, apparatuses and terminals. Other devices, such as other scanners, printers and multi-function devices may also be connected to a network, as is well known in the art. Further, the network devices, score calculating apparatus 100, score computing part 100a, RFP generating part 100b, report generating part 100c, and output part 100b may be connected in a network arrangement different than that depicted in FIG. 1.

The score calculating apparatus 100 of the present invention may be realized by a computer program product including a computer-usable, non-transient medium (such as a disk storage apparatus) having instructions tangibly embodied therein that are executed by a computer. Thus, it should be understood that the score calculating apparatus 100 may be executed on a computer. The score computing apparatus may be executed on a client terminal and/or network-connected device. The functionalities of the score computing part 100a may be provided by a software application such as a dedicated financial software application, another application, an operating system (OS), or firmware, operating on a terminal and/or network-connected device.

The score calculating apparatus 100 may include a data storage system that can comprise one or more structural or functional parts that have or support a storage function. For example, the data store can be, or can be a component of, a source of electronic data, such as a document or financial data access apparatus, a backend server connected to a document or financial data access apparatus, an e-mail server, a file server, a multi-function peripheral device (MFP or MFD), an application server, a computer, a network apparatus, or a terminal. It should be appreciated that the term “electronic document” or “electronic data”, as used herein, in its broadest sense, can comprise any data that a user may wish to electronically access, retrieve, review, or otherwise use.

Score calculating apparatus 100 is not limited to a computer or server, but can be manifested in any of various devices that can be configured to communicate over a network and/or the Internet, including but not limited to a personal, notebook or workstation computer, a terminal, a kiosk, a PDA (personal digital assistant), a tablet computing device, a smartphone, a server, a mobile phone or handset, or another information terminal. Each device may be configured with software allowing the device to communicate through networks with other devices. It should be understood that the score calculating apparatus 100 may be the device that is actually performing, with its output part 100b, an output job (e.g. an e-mail, a transmission to separate financial software, a printer or automated call-in system, a display on a screen, or other electronic action making beneficial use of the calculated score(s) or presenting the calculated score(s) to an investment advisor), or the score calculating apparatus may be connected via the network 11 to another device (such as MFD 14-3 or printer 14-4) that is performing the output job. Similarly, it should be understood that one or more of the processing functions described above as being performed by the score computing part 100a, the RFP generating part 100b, and/or report generating part 100c, may instead be performed by another device connected to the score calculating apparatus 100 via the network 11, such as terminal 14-1, MFD 14-3 or server 14-5. The score calculating apparatus 100 and the various processing functions described above may be implemented using cloud based processing over a cloud network. For example they may be implemented on “platforms as a service,” such as are offered by salesforce.com.

FIG. 1A shows one embodiment where the score computing part 203a, RFP generating part 203b, and report generating part 203c are included as parts of a computer terminal 23 connected to exemplary network 11. FIG. 1B shows another embodiment where the score computing part 204a, RFP generating part 204b, and report generating part 204c are included as part of a server 24 also connected to an exemplary network 11. FIG. 1C shows a further embodiment where the score computing part 205a, RFP generating part 205b, and report generating part 206c are parts of a stand-alone workstation 25 connected to a network 26 which may take any of the variety of forms, which are readily known in the art. Again, FIGS. 1-1C are merely indicative of the breadth of such arrangement of electronics, computers and computing devices, which may be used to carry out the inventive methods disclosed herein and are not intended to limit those to which the invention may be applied. For example, two or more of the score computing part, RFP generating part, and report generating part may instead be implemented as a multi-function part.

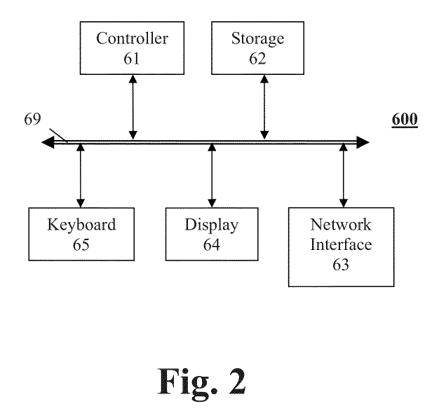

FIG. 2 shows an exemplary arrangement of a score calculating apparatus as a computer, for example, that can be configured through software to provide the score calculating apparatus 100 illustrated in FIG. 1. As shown in FIG. 2, the score calculating device 600 includes a controller (or central processing unit) 61 that communicates with a number of other components, including memory or storage part 62, network interface 63, display 64 and keyboard 65, by way of a system bus 69.

The score calculating device 600 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as will be appreciated to those skilled in the relevant arts.

In score calculating device 600, the controller 61 executes program code instructions that control device operations. The controller 61, memory/storage 62, network interface 63, display 64 and keyboard 65 are conventional, and therefore in order to avoid occluding the inventive aspects of this disclosure, such conventional aspects will not be discussed in detail herein.

The score calculating device 600 includes the network interface 63 for communications with other devices through a network. However, it should be appreciated that the subject matter of this disclosure is not limited to such configuration. For example, the score calculating device 600 may communicate with client and/or other terminals through direct connections and/or through a network to which some components are not connected. As another example, the score calculating device 600 need not be provided by a server that services terminals, but rather may communicate with the devices on a peer basis, or in another fashion.

In one embodiment, score calculating apparatus 100 may be manifested as a multi-function device, which may be any apparatus (including a microprocessor chip or a collection of devices having varying degrees of integration) that has the ability to perform two or more functionalities. The multi-function device may be a terminal or any computing device including but not limited to a personal, notebook or workstation computer, a kiosk, a PDA (personal digital assistant), a tablet computing device, a smartphone, a server, a mobile phone or handset, or another information terminal. The multi-function device may be created expressly for the purpose of performing the methods of the present invention, or it may perform the methods with the use of software later loaded onto the multi-function device.

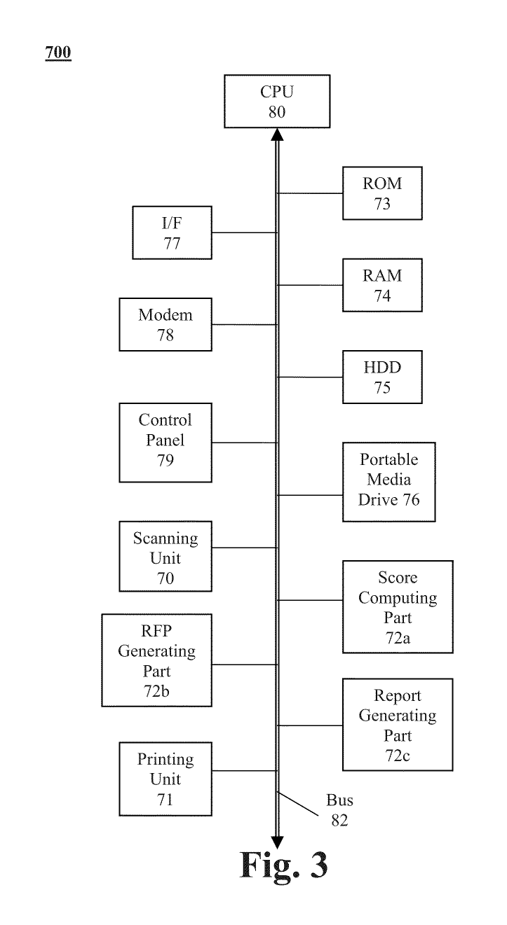

An example of a configuration of a multi-function device is shown schematically in FIG. 3. Device 700 includes a central processing unit (CPU) 80, and various elements connected to the CPU 80 by an internal bus 82. The CPU 80 services multiple tasks while monitoring the state of the device 700. The elements connected to the CPU 80 include a scanning unit 70, a printing unit 71, a score computing part 72a, a RFP generating part 72b, a report generating part 72c, a read only memory (for example, ROM, PROM, EPROM, or EEPROM) 73, a random access memory (RAM) 74, a hard disk drive (HDD) 75, portable media (for example, floppy disk, optical disc, magnetic discs, magneto-optical discs, or semiconductor memory cards) drive 76, a communication interface (I/F) 77, a modem unit 78, and a control panel 79.

Program code instructions for the device 700 can be stored on the read only memory 73, on the HDD 75, or on portable media and read by the portable media drive 76, transferred to the RAM 74 and executed by the CPU 80 to carry out the instructions. These instructions can include the instructions to the device to perform specified ones of its functions and permit the device 700 to interact with other network devices, and to control the operation panel 79 and the score computing part 72a of the device 700. The control panel 79 includes a display screen that displays information allowing the user of the device 700 to operate the device 700, and optionally to display as output one or more scores for financial products determined by the score computing part 72a. The display screen can be any of various conventional displays (such as a liquid crystal display, a plasma display device, or a cathode ray tube display), but preferably allows the operator to conveniently take advantage of the services provided by the system. The display screen does not need to be integral with, or embedded in, the operation panel 79, but may simply be coupled to the operation panel by either a wire or a wireless connection. The operation panel 79 may include keys for inputting information or requesting various operations. Alternatively, the operation panel 79 and the display screen may be operated by a keyboard, a mouse, a remote control, touching the display screen, voice recognition, or eye-movement tracking, or a combination thereof. The device 700 is a multifunction device (with scanner, printer, score computing, and RFP and report generation) and in addition can be utilized as a terminal to download documents or financial information from a network.

Additional aspects or components of the device 700 are conventional (unless otherwise discussed herein), and in the interest of clarity and brevity are not discussed in detail herein. Such aspects and components are discussed, for example, in “How Computers Work,” by Ron White (Que Corporation 1999), and “How Networks Work,” by Frank J. Dealer, Jr. and Les Freed (Que Corporation 2000), the entire contents of each of which are incorporated herein by reference.

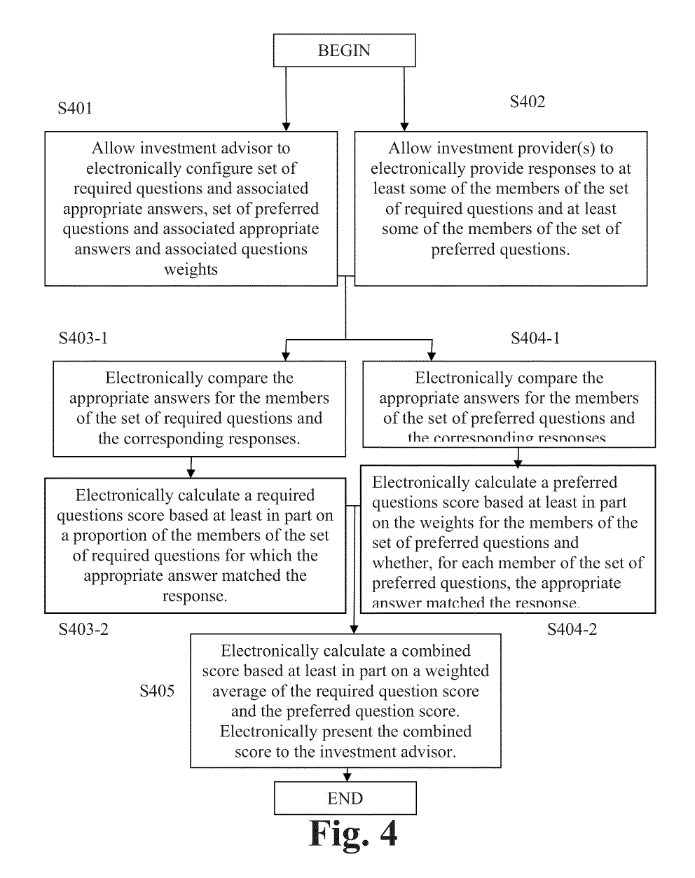

FIG. 4 is a flow diagram giving an overview of the process of the invention according to one embodiment.

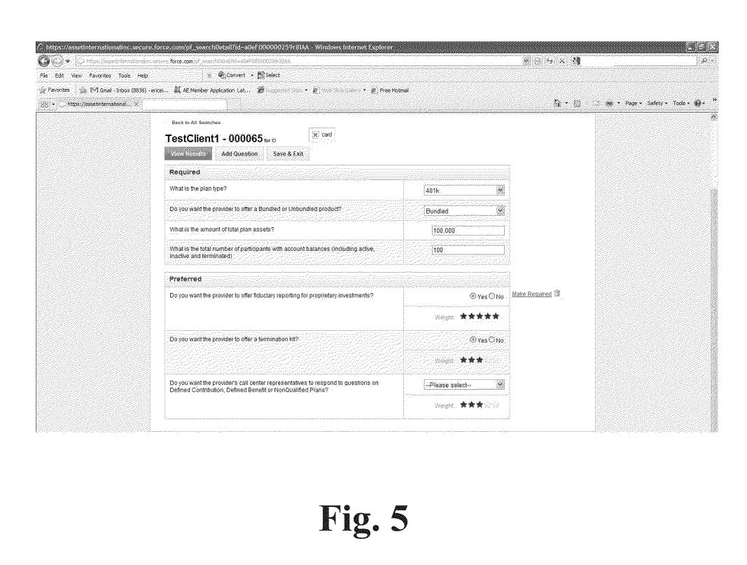

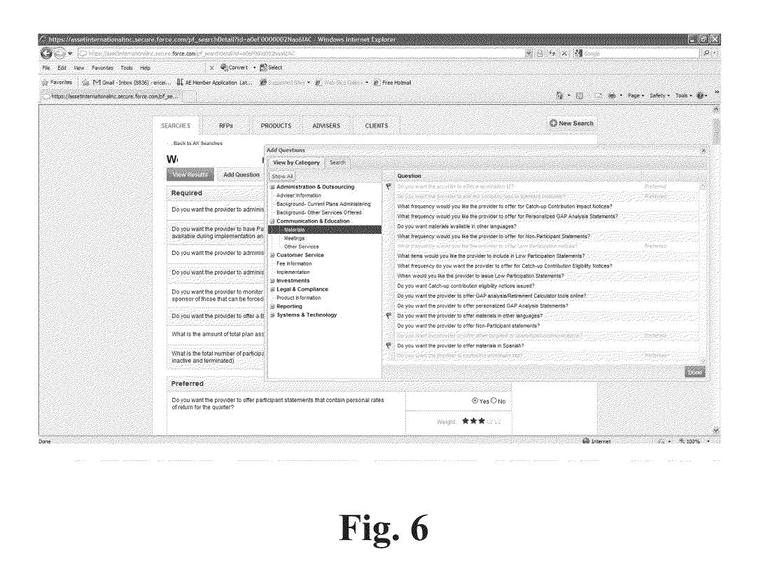

At step S401, an investment advisor (or, alternately, another entity), is allowed to electronically configure a set of required questions and associated appropriate answers for the members of this set of required questions, a set of preferred questions and associated appropriate answers for the members of this set of preferred questions. Preferably, the investment advisor will designate the set of required questions as those which are required to be answered appropriately for his or her client to consider doing business with a financial product provider. Preferably, the investment advisor will designate the set of preferred questions as those which would provide some additional benefit to his or her client, but which are not required to be answered in a certain way. However, it is within the scope of the present invention that the set of required questions and set of preferred questions be composed of any questions chosen by the investment advisor. FIG. 6 shows a screenshot of one possible user interface which allows the investment advisor to browse for, and add, additional questions to either of the set of required questions or the set of preferred questions. FIG. 5 shows a screenshot of one possible user interface for configuring appropriate answers for the members of the set of required questions and members of the set of preferred questions. It will be understood that appropriate answers may be electronically inputted by use of a drop-down menu, selection of one of several bullet-points, entry of text, or other electronic input methods as are known in the art. By selecting to add a question, a user interface such as that shown in FIG. 6 may be presented to the investment advisor, and the investment advisor may browse for (such as by category) and select questions to add to the set of required questions or the set of preferred questions. Advantageously, the investment advisor may search for questions, such as with a word search. Alternately, in some embodiments the investment advisor may input and add a question that he or she creates. Advantageously, as shown in FIG. 5, the investment advisor may also use a user interface to make a preferred question into a required question (or, as will be understood, to make a required question into a preferred question), or to delete questions, such as by clicking on a “trash-can” icon.

In some embodiments, the investment advisor or another entity may “flag” certain questions which may be of importance in the future. Such flagged questions may be saved by the system and separately presented or emphasized to the investment advisor when he subsequently configures sets of required and/or preferred question, such as during future searches. In certain embodiments, the advisor can save templates including the set of required and/or the set of preferred questions for future use, such as when performing searches for similar clients.

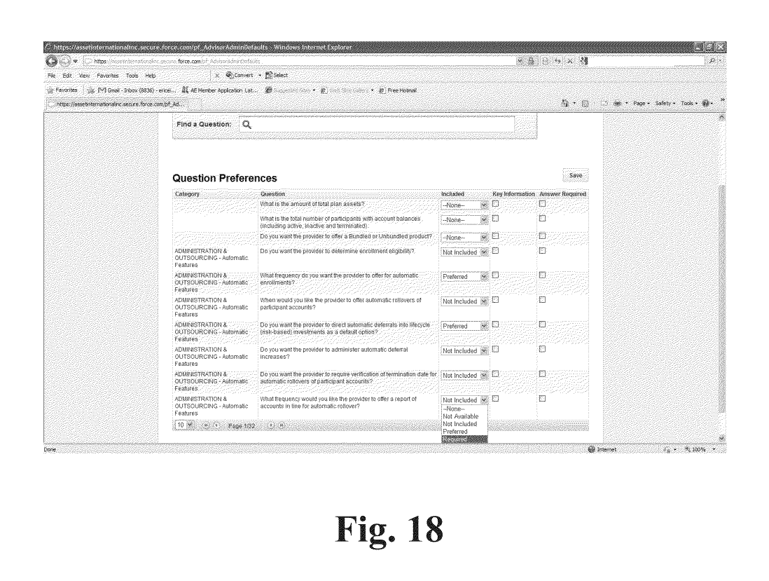

Certain questions may be set up as the investment advisor's default questions, and the investment advisor may be precluded from removing certain questions. For example, in some embodiments, an administrator, from an organization of which the investment advisor is part, may be allowed to electronically configure a first set of investment advisor questions to be included in the set of required questions by default, and the investment advisor may be precluded from removing at least some of this first set of investment advisor questions when configuring the complete set of required questions. Additionally or alternatively, in some embodiments, the administrator may be allowed to electronically configure a second set of investment advisor questions to be included the set of preferred questions by default, and the investment advisor may be precluded from removing at least some of the second set of investment advisor questions when configuring the set of preferred questions. The administrator may set up these default and/or mandatory settings through, for example, a user interface as shown in FIG. 18, where the administrator may select certain questions as default preferred investment advisor questions or default required investment advisor questions, and may check a “Answer Required” box to prevent the investment advisor from removing a question.

Although any collection of questions may be available for inclusion by the investment advisor into the set of required questions and the set of preferred questions, and any such collection would be within the scope of the present invention, the following chart shows examples of some of the questions. As seen in the below chart, CategoryName shows the category where an investment advisor could locate the question when browsing, such as shown in FIG. 6, ProviderQuestion shows the wording of the question that may be given to the financial product provider(s) to provide a response, AdvisorQuestion shows the wording of the question that may be shown to the investment advisor, and AnswerType shows the type of appropriate answer and response which may be electronically inputted by the investment advisor and financial product provider(s) respectively:

| CategoryName | ProviderQuestion | AdvisorQuestion | AnswerType |
|---|---|---|---|
| ADMINISTRATION & | Do you determine enrollment | Do you want the provider to | YesNo |
| OUTSOURCING - | eligibility? | determine enrollment | |
| Automatic Features | | eligibility? | |
| ADMINISTRATION & | How is the timing for | Do you want the timing for | MultiChoice |
| OUTSOURCING - | automatic increases | automatic increases to be | |
| Automatic Features | determined? | set at plan level or can it be | |
| | | participant defined? | |
| ADMINISTRATION & | Following the receipt of a | Following the receipt of a | Picklist |
| OUTSOURCING - | request, what is the target | request, what is the | |
| Distributions/ | number of business days | maximum acceptable | |
| Withdrawals | required to approve a | number of business days | |
| | hardship? | required to approve a | |
| | | hardship? | |
| ADMINISTRATION & | Do you check that the match | Do you want the provider to | YesNo |
| OUTSOURCING - | received equals the plan | check that the match | |
| Edits | match formula? | received equals the plan | |
| | | match formula? | |
| ADVISER | Will you allow an adviser to | Do you want the provider to | YesNo |
| INFORMATION - | develop plan specific asset | allow the adviser to develop | |
| Adviser Information | allocation models (target | plan specific asset allocation | |
| | date and/or lifestyle) using | models (target date and/or | |
| | any funds? | lifestyle) using any funds? | |
| BACKGROUND - | Do you administer Taft | Do you want the provider to | YesNo |
| Current Plans | Hartley plans? | be able to administer Taft | |
| Administering | | Hartley plans? | |
| COMMUNICATION & | Are materials available in | Do you want the provider to | YesNo |
| EDUCATION - | Spanish? | offer materials in Spanish? | |
| Materials | | | |
| FEE INFORMATION - | What is the minimum | What is the minimum | Picklist |
| Fee Information | contract period required? | contract period required? | |
| IMPLEMENTATION - | Is the reconciliation and | Do you want the provider to | YesNo |
| Implementation | documentation made | make the reconciliation and | |
| | available to plan sponsors? | documentation available to | |
| | | plan sponsors? | |
| INVESTMENTS - | Can the brokerage window | Do you want the provider to | Picklist |
| Brokerage Window | be limited to mutual funds | offer all mutual funds or a | |
| | only? | specified list of mutual funds | |
| | | in Self-Directed Brokerage | |
| | | Account (SDBA)? | |
| LEGAL & | To maximize 404(c) | Do you want the provider to | YesNo |
| COMPLIANCE - 404c | coverage, will you identify | identify participant accounts | |
| | participant accounts that | that have been defaulted | |
| | have been defaulted and | and contact for affirmative | |
| | contact for affirmative | investment elections? | |
| | investment elections? | | |
| PRODUCT | Where are the call centers | Where are the call centers | Text |
| INFORMATION | based (city(ies), state(s))? | based (city(ies), state(s))? | |
| PRODUCT | What is the size range in | What is the total number of | NumberRange |
| INFORMATION | number of participants? | participants with account | |
| | | balances (including active, | |
| | | inactive and terminated) | |
| REPORTING - | Do you provide reporting on | Do you want the provider to | MultiChoice |
| Fiduciary Reporting | how the plan's investments | provide reporting on how the | |
| | are performing against | plan's investments are | |
| | criteria established in the | performing against criteria | |
| | investment policy? | established in the | |
| | | investment policy? | |
| SYSTEMS & | What is the maximum funds | What is the maximum funds | Number |
| TECHNOLOGY - | per plan (enter 999999 for | per plan (enter 999999 for | |
| Limitations | unlimited)? | unlimited)? | |
| zBlank | What is the maximum | What is the maximum | Picklist |
| | participant size for this | participant size for this | |
| | product? | product? | |

As a further part of S401, the investment advisor also selects a weight for each of the members of the set of preferred questions. As will be discussed below in connection with S404, this weight may be used in calculating a preferred question score, with questions of higher weight having a greater impact on the preferred question score than questions of lower weight. As shown in FIG. 5, this may be done by selecting a number of whole stars from 1 to 5 inclusive (which correspond to the integers from 1 to 5 inclusive). A default value, such as 3, may automatically be selected when a question is added, but be electronically changeable to a new value at the investment advisor's discretion. Other methods of inputting weights for the preferred questions may also be used, for example, inputting any number from 1 to 100 or any other method known in the art for ranking items according to importance. In some embodiments, the investment advisor may be allowed also to input weights for required questions, or, as shown in FIG. 5, may be precluded from inputting any weights for the required questions. In one embodiment, inputted weights for required questions may have no effect on the required question score discussed below in connection with S404. The weights will be used in calculating the preferred and combined scores for the relevant financial products, as will be discussed further in connection with steps S404 and S405 below. In embodiments in which the investment advisor is allowed to input weights and the weights have effect, the required question score may be calculated in the same manner as the preferred question score, as discussed below in connection with step S404.

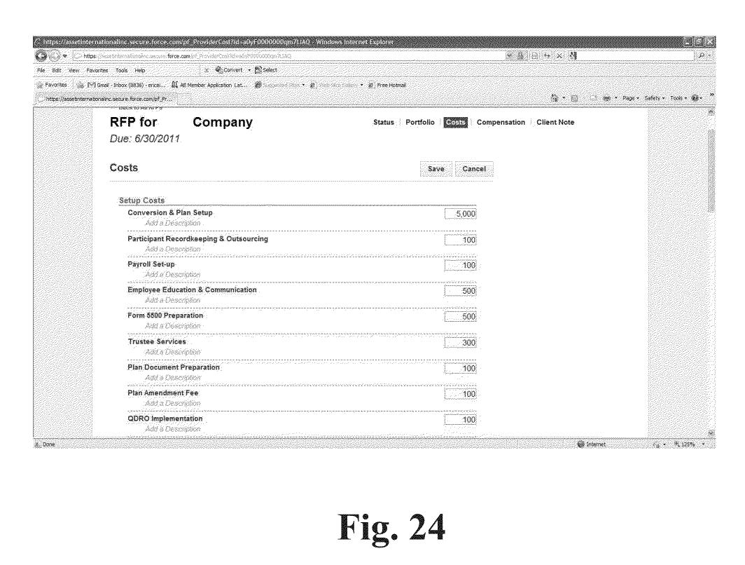

Step S402 may occur prior to step S401, such as if one or more investment providers have previously received a complete list of questions to answer, or it may occur after S401, such as if the one or more investment providers are asked to respond to a request for proposal (“RFP”) generated in response to step S401 and sent to the one or more investment providers. In the latter case, the investment providers might choose to limit their responses to only those inquired about in the RFP or they might choose to answer all available questions so that responses may be automated for future inquiries. In either event, the required questions and the preferred questions selected by the investment advisor are presented to the investment provider. As shown in the table of questions above, the wording of the questions may presented to the investment provider may differ from the wording presented to the investment advisor as appropriate. At step S402 the one or more investment providers electronically provide responses to at least some of the members of the set of required questions and at least some of the members of the set of preferred questions. If the investment provider declines to provide a response to some of these questions, the non-response will be treated as a non-matching answer in steps S403 and S404, which will be discussed further below. Responses may be electronically provided by the investment provider, as by the user interface as shown in FIG. 24, (which was created as the result of the generation of an RFP after an investment advisor completed step S401 and requested that an RFP be sent to the particular investment provider) by simply entering responses to the various questions. Other methods, such as, without limitation, use of pull-down menus or a selection from amongst multiple bulletpoints, may also be used. The responses are electronically collected, and may be transmitted, for example over the networks of the computer systems shown in the FIGS. 1-1C, to a score computing part 100a.

At step S403, the appropriate answers for the members of the set of required questions and the corresponding provider responses are electronically compared. A required question score is calculated based at least in part, or entirely, on a proportion of the members of the set of required questions for which the appropriate answer matched the response. In an example, if there were y members of the set of required questions and x of these members matched, then the required question score would be x/y. It could be expressed as a score out of 100 or a percentage, and a floor or ceiling could be taken, i.e. floor(100*x/y) or ceiling(100*x/y), or rounding performed. In an alternate embodiment, the required score would be perfect e.g. 100 if all of the members of the set of required questions are matched, and 0 otherwise. In yet another alternate embodiment, the combined score, discussed below in connection with step S405, would be set to 0 in the event that not all of the required questions matched.

At step S404, the appropriate answers for the members of the set of preferred questions and the corresponding responses are electronically compared. A preferred question score is calculated based at least in part on the weights for the individual members of the set of preferred questions and whether, for each member of the set of preferred questions, the appropriate answer matched the response. For example, if the matching preferred questions had a total, summed weight of n, and if all of the non-matching preferred questions, had a total, summed weight of m, the preferred question score could be calculated as n/(n+m). In the particular situation shown in the following chart, involving 4 preferred questions, the preferred question score could be calculated as (sum of weights of matched preferred questions)/(sum of weights of all preferred questions) or (5+4)/(5+4+3+3), or 9/15 or 0.6 or 60 out of 100 or 60%.

| Preferred Question # | Matched? | Weight |
|---|---|---|
| 1 | Yes | 5 |
| 2 | Yes | 4 |
| 3 | No | 3 |
| 4 | No | 3 |

A floor or ceiling may be taken, (that is, rounding down or up, respectively, to the nearest integer) or rounding performed. Thus 71.7% could be floored to 71%, ceilinged to 72%, or rounded to 72%. 71.3% could be floored to 71%, ceilinged to 72%, or rounded to 71%.

At step S405, a combined score is electronically calculated based at least in part on a weighted average of the required question score and the preferred question score. The weight for the required question score may be electronically set to a default value. Values of 70%-75% (or 0.7 to 0.75) are preferred. 70% (0.7) in particular is preferred. The investment advisor may be precluded from changing the default value. For example, if the weight for the required question score is r, the required question score is a, and the preferred question score is b, then the combined score could be calculated as r*a+(1−r)*b. Thus, if the weight of the required question score is known to be 80%, it can be inferred that the weight of the preferred question score is 100%-80% or 20%, and the calculation would be 0.8*a+0.2*b.

Alternately, the investment advisor may be allowed to electronically configure weights for the required question score and the preferred question score to be used in the calculation of the combined score, such as by altering the default value to another value of his or her choosing, or by setting the default value in the first instance. It should be noted that, if these two weights are set to total 1 (or 100%), then, by changing or choosing the weight for the required question score, it is understood that also automatically changes the weight for the preferred question score (and, by changing or choosing the weight for the preferred question score, it is understood that also automatically changes the weight for the required question score).

It should be noted that the electronic calculation of the preferred question score and the required question score can be done simultaneously with, and as a part of, the electronic calculation of the combined score. That is, unlike previously embodiments where preferred and required scores are separately calculated, the combined score may be calculated in a single step. For example, given a required question category weight of 0.8, and the following chart, involving 2 required questions and 2 preferred questions, the combined score might be calculated as 0.8(number of required questions matched)/(number of required questions)+0.2(total weight of preferred questions matched)/(total weight of all questions) or 0.8(1/2)+0.2(4/(2+4)), or 0.4+0.133 or 0.533 or 53.3%:

| Required/Preferred? | Matched? | Weight? |
|---|---|---|
| Required | Yes | N/A |
| Required | No | N/A |
| Preferred | Yes | 4 |
| Preferred | No | 2 |

Although the combined score is calculated more directly in this embodiment, the required score and preferred score are still calculated as part of the combined score calculation. Such a direct calculation of the combined score based on the above-discussed factors will be understood as also involving the calculation of a required question score and a preferred question score, despite any variation in the order of the calculations performed or the order of the underlying mathematical operations.

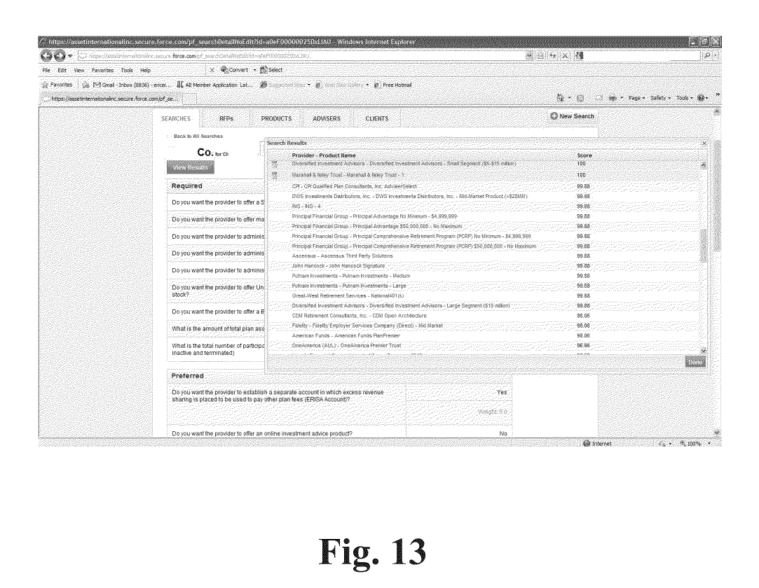

As an additional part of S405, the combined score, for one or more financial products, is electronically presented to the investment advisor. This may be in the form of a listing of the one or more financial products and their respective scores. A screenshot of a user interface showing an illustrative portion of such a listing is shown in FIG. 13. A special visual symbol may be provided for, and only for, those of the one or more financial products for which the response matches the appropriate answer for all of the members of the set of required questions. The special visual symbol may be an image. For example, in FIG. 13, a star-shaped badge is placed next to the financial products which meet all of the required questions. However, other forms of electronic presentation, for example and without limitation, the sending of an e-mail containing one or more combined scores to the investment advisor over a computer network, are within the scope of the present invention. In this FIG. 13, the electronic presentation is in the form of a ranking according to the financial products' respective combined scores, in descending order.

The investment advisor may also be electronically presented with, for the one or more financial products, one or more or all of the following: the number of required questions for which the appropriate answer matched the response, the number of preferred questions for which the appropriate answer matched the response, the number of members in the set of required questions, and the number of members in the set of preferred questions.

After electronically presenting the combined score for the one or more financial products to the investment advisor, the investment advisor may be allowed to select a financial product for which the appropriate answer did not match the response for one or more of the members of the set of required questions. If the investment advisor does this, the investment advisor may be electronically presented, for the selected financial product with the associated question, the associated appropriate answer, and the associated response for each of the members of the set of required questions for which the appropriate answer did not match the response. This allows the investment advisor to better understand the drawbacks of using the particular financial product. The investment advisor may choose one or more of the financial products for inclusion in a report, for the generation of one or more RFPs to obtain further information about the financial products, or for purchase.

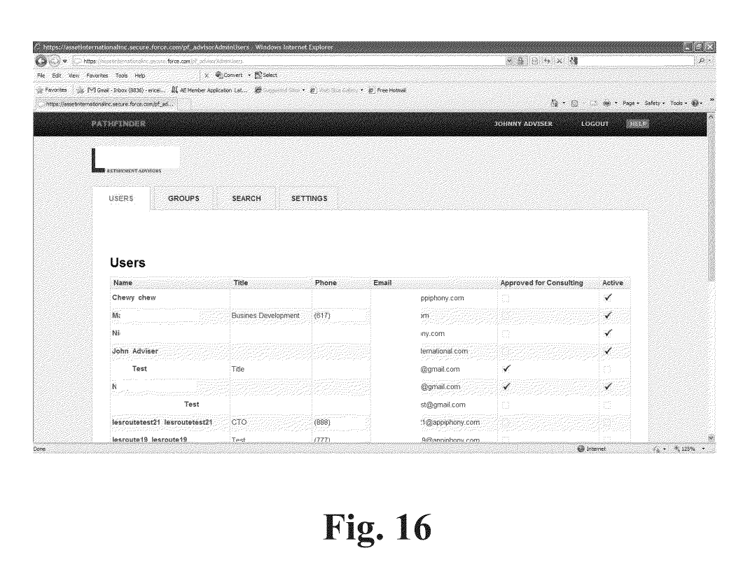

An administrator or anyone tasked with the responsibility of limiting the investment advisor's use of the inventive methods, from an organization of which the investment advisor is a part, may electronically indicate that one or more financial products are approved. This indicated approval may be approval by the organization. An electronic indication may be received of whether the investment advisor is acting in a consulting capacity. This indication may be electronically sent, for example, by the investment advisor or by the administrator or by anyone else using the system. FIG. 16 shows a screenshot of a user interface for an administrator to electronically indicate whether particular financial advisors are approved for consulting. When electronically presenting the combined score for the one or more financial products to the investment advisor, results from financial products that are not approved may be filtered out if the indication is that the investment advisor is not acting in a consulting capacity. This prevents non-consulting advisors, who, within some investment advising firms, have less freedom in choosing financial products than do advisors acting in a consulting capacity, from further evaluating financial products that have not been deemed appropriate by the investment advising firm.

In certain embodiments, the administrator may create groups of users and assign a variety of settings to each user in the group. For example, a particular group may include a number of investment advisors. The settings applied to the group may include, for example, a particular logo, a particular name such as a firm or team name, a particular list of approved financial products, and the availability or unavailability of at least some of the various system features discussed herein or other system features.

In another embodiment, after the combined score for the one or more financial products is electronically presented to the investment advisor, the investment advisor may be allowed to electronically request generation of a RFP for one or more of the one or more financial products that are approved. The investment advisor may also be precluded from electronically requesting generation of a RFP for those of the one or more financial products that are not approved. This preclusion may only apply if an electronic indication has been received that the investment advisor is not acting in a consulting capacity. The one or more requested RFPs may be electronically generated and transmitted to the one or more investment providers who provide the associated financial products.

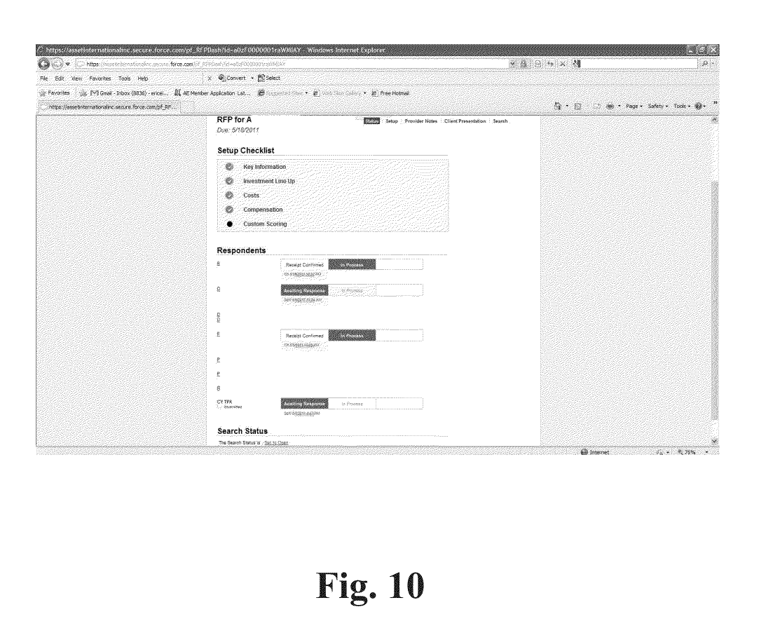

The investment advisor may be kept abreast electronically of the status of the RFPs, such as through a status update user interface, for example, that shown in FIG. 10. The status update user interface may indicate status events for one or more financial products including confirmed receipt of the RFP by the investment provider, whether the investment provider has declined to proceed with the RFP, whether the investment provider is in the process of completing the RFP, whether the RFP has been completed by the investment provider, whether the completed RFP has been sent back to the investment advisor, completion and due dates for the foregoing, whether the RFP process has been closed to further responses, such as by the investment advisor or due to the passage of time beyond a due date, and the like.

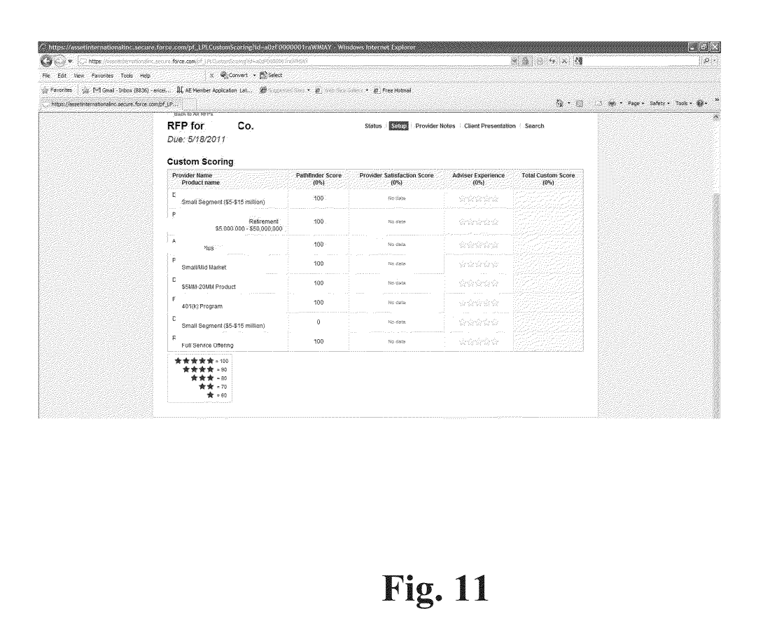

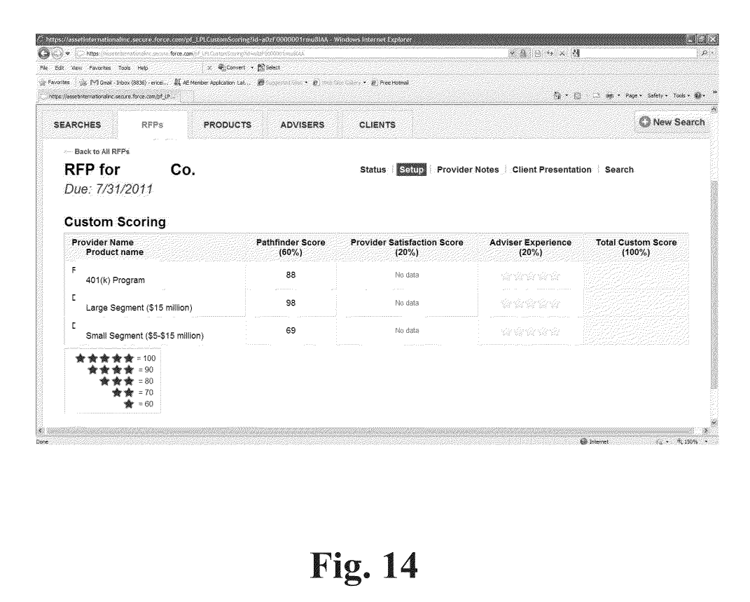

A report may be electronically generated, which may be useful to the investment advisor in keeping compliant with reporting regulations and in presenting results of his or her investment search to his or her client. The report may have more than one section. The report may comprise the set of required questions, the set of preferred questions, the appropriate answers for the members of the set of required questions, the appropriate answers for the members of the set of preferred questions, and, for at least one financial product, the associated responses and the combined score. The investment advisor may be allowed to electronically select the at least one financial product which is included in the report and may also be allowed to select the order of these financial products within the report. The report may further comprise at least one comment from at least one of the investment advisor and the investment provider associated with the at least one financial product. The investment advisor may be allowed to select which of a plurality of sections are included in the report and the relative order of the sections that are included in the report. As shown for example in FIGS. 11 and 14, in which the “Pathfinder Score” column refers to a combined score, the investment advisor may electronically assign a weight for the combined score (in the case of FIG. 14, 60%) and a weight for at least one additional factor (in the case of FIG. 14, 20% for a “Provider Satisfaction Score”, such as may correspond to a score assigned to the provider of the financial product based on feedback from the provider's previous customers, and 20% for the “Advis[o]r's Experience”, such as may correspond to a score assigned by the advisor based on the advisor's opinion). Once these weights are assigned, a total score for the one or more financial products may be calculated based at least in part on a weighted average of the combined score and the at least one additional factor. The report may further include this total score for the at least one financial product.

In certain embodiments, the investment advisor, or another entity, can also store information about the investment advisor to be included in the report. For example, the investment advisor may specify a name, logo, and description to be saved and included in the report. The entity may also set up profiles for other users, which store similar information about the other users, to be included when these other users should be reflected in the report. For example, the investment advisor may set up separate profiles for when operating independently and when operating as part of a larger firm and/or team.

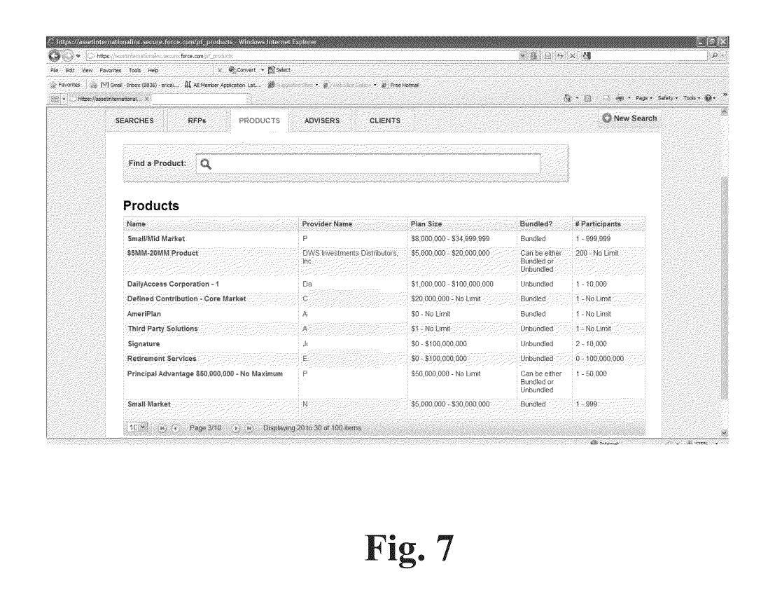

FIG. 7 is a screenshot of a user interface showing a variety of financial products to an investment advisor, particularly retirement plans, including the name of the provider of the financial product, the size of the plan, whether the plan comes bundled or unbundled, and the number of participants.

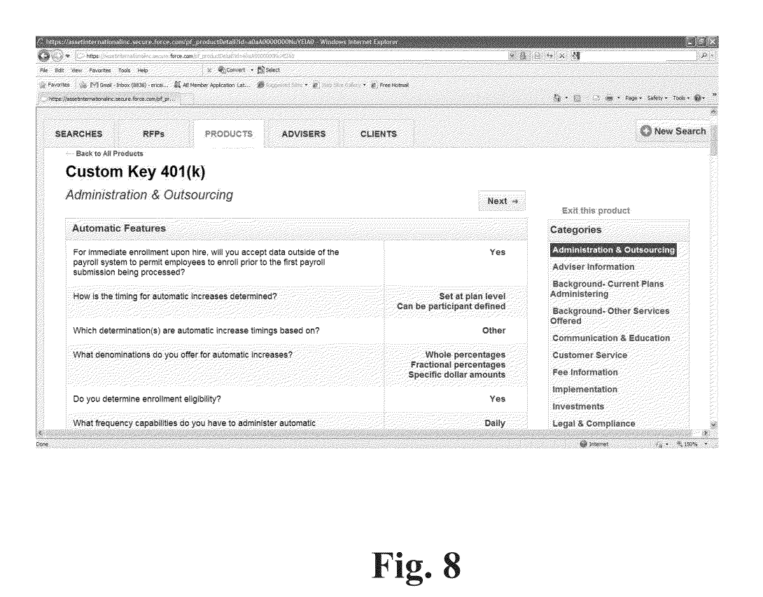

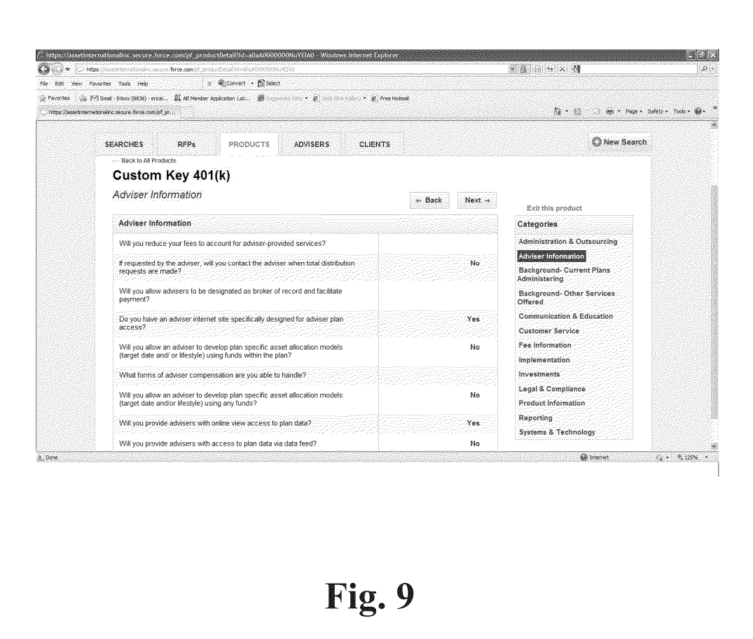

FIGS. 8-9 are screenshots of user interfaces showing more detailed information about a particular financial product, in this case a “Custom Key 401(k)”. The information shown, for each of a number of separately listed categories, includes a question and the investment provider's response. To the extent a response is not provided, the associated space is left blank.

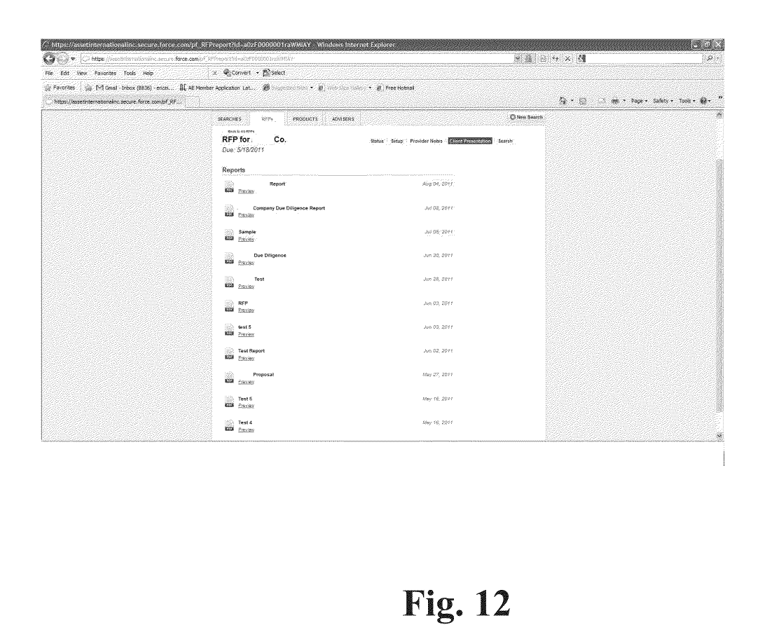

FIG. 12 is a screenshot of a user interface for the investment advisor to preview, or download in PDF form, a number of previously generated RFPs and reports for various financial products.

FIG. 13 is a screenshot of a user interface for the display of combined scores for a variety of financial products and special visual symbols for those financial products matching all of the required questions. Special visual symbols may alternately or additionally be used for financial products whose combined score is at or above some threshold value.

FIG. 14 is a screenshot of a user interface showing how custom factors may be used, in addition to the combined score (here, labeled “Pathfinder Score”), to electronically generate a total custom score. The weights of the combined score and the other factors may be set by default and/or configured by the investment advisor or administrator.

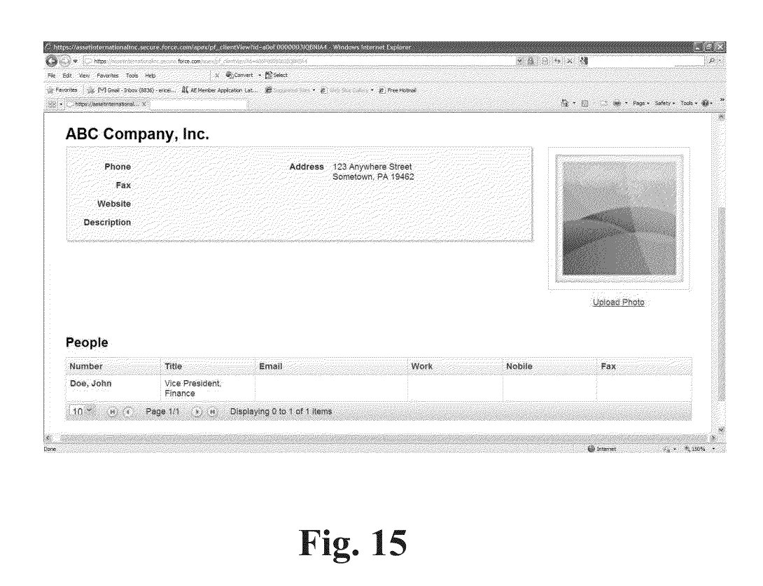

FIG. 15 is a screenshot of a user interface for the investment advisor to view detailed information about a particular investment provider, including contact information and relevant persons at the investment provider organization.

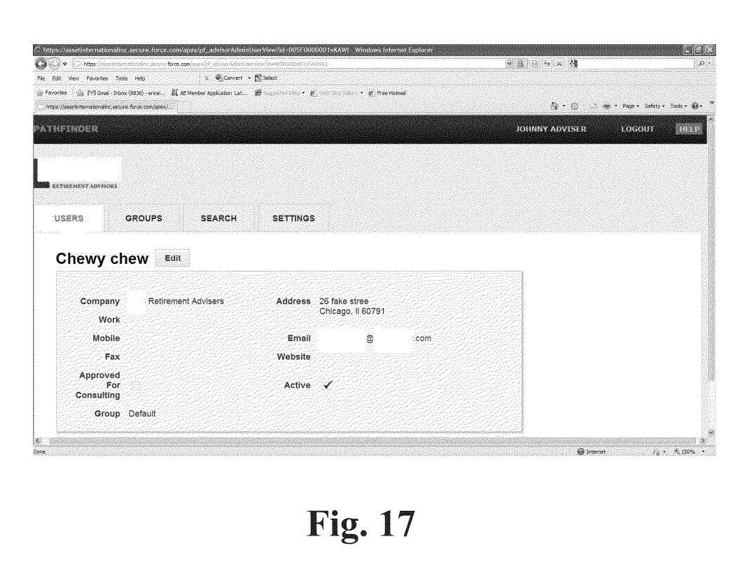

FIG. 17 is a screenshot of a user interface showing detailed information about a particular investment advisor, including contact information, and whether the investment advisor is approved for consulting, and active (that is, whether the investment advisor is permitted to use the system).

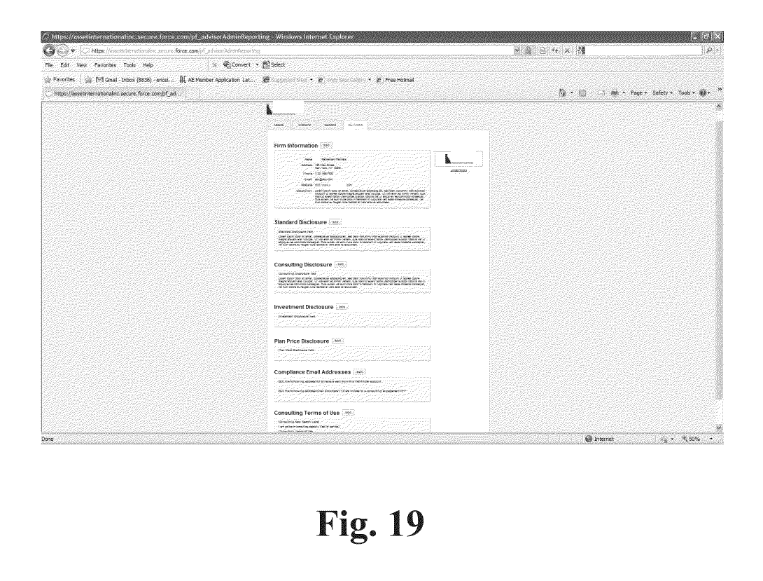

FIG. 19 is a screenshot of a user interface for an investment advisor to edit various sections which could be included in a report and/or RFP, including information about the advisor's investment firm, a standard disclosure, a consulting disclosure and consulting terms of use (which may be incorporated in the RFP and/or report only if the adviser is acting in a consulting capacity), an investment disclosure, a plan price disclosure, and compliance e-mail addresses.

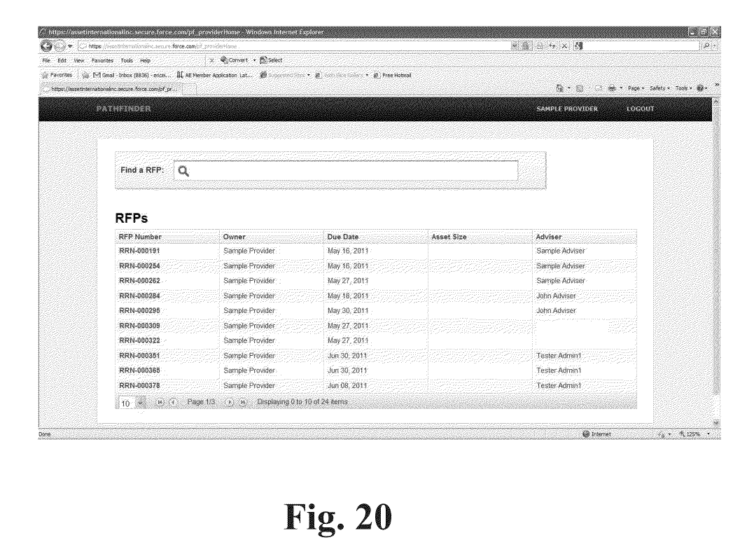

FIG. 20 is a screenshot of a user interface for an investment provider to access a number of RFPs submitted by investment providers, for the purposes of responding thereto. The due date for a response, the name of the investment advisor submitting the RFP, if available, the size of the asset that the investment adviser hopes to invest in the financial product, are shown.

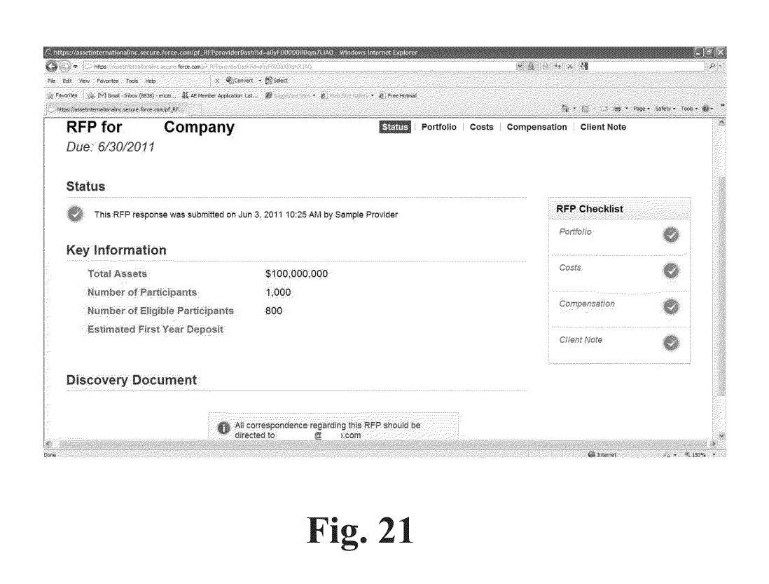

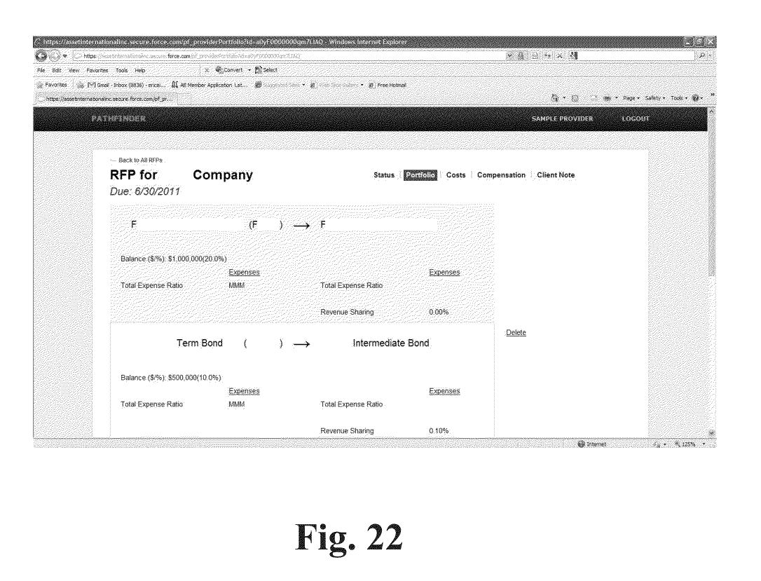

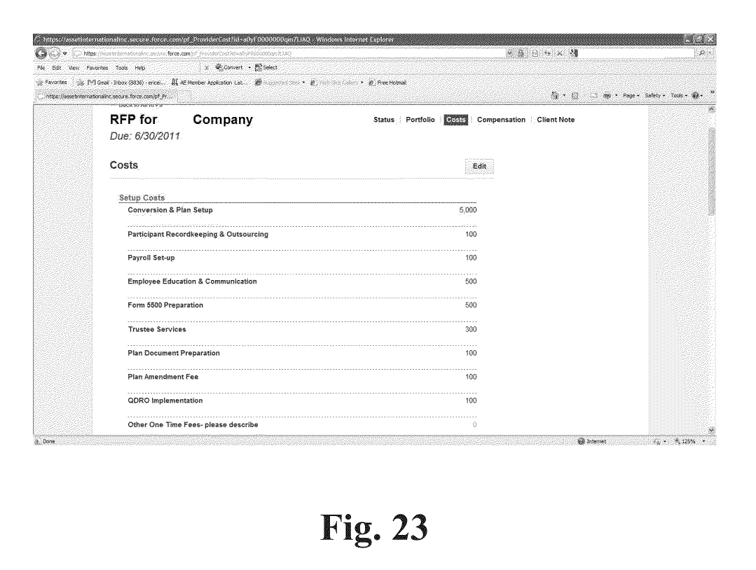

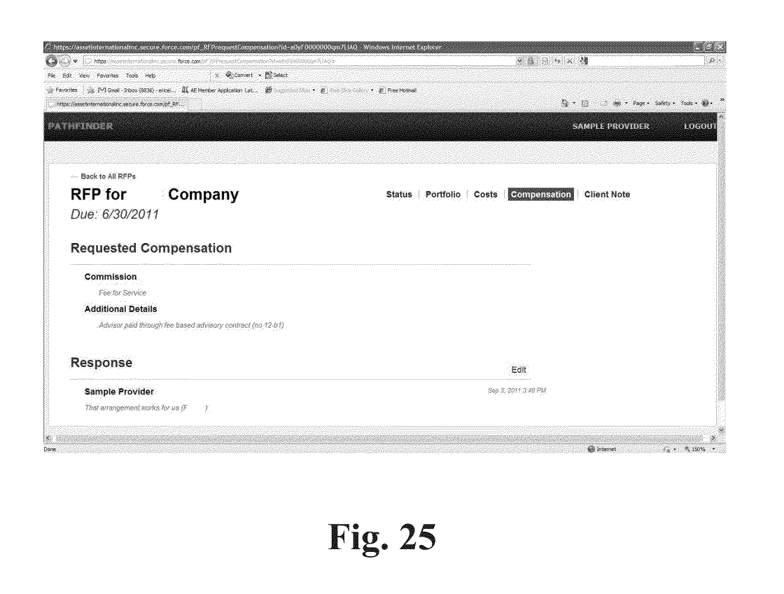

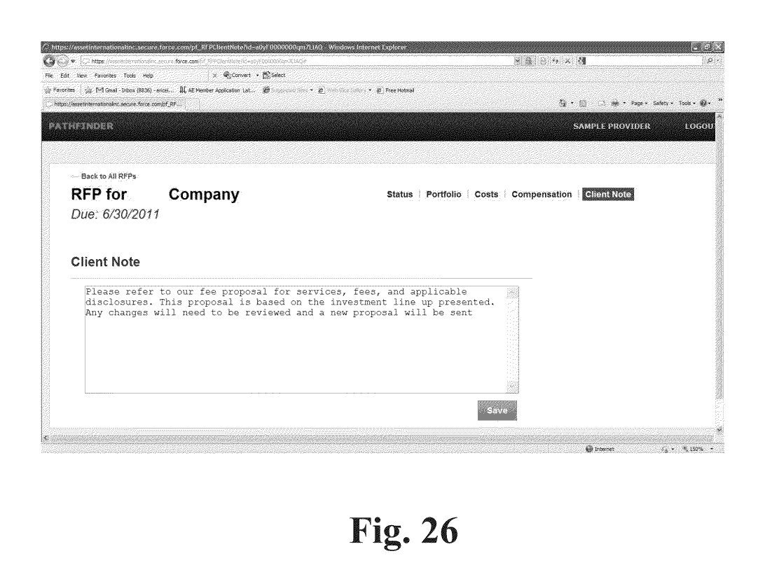

FIGS. 21-26 are screenshots of user interfaces showing more detailed information about a particular RFP, including the date due, the date of a response, an assortment of information that has been identified as key (as through the user interface shown in FIG. 18). An RFP checklist is provided showing whether various steps involved in answering the RFP have been accomplished. The “Edit” button of FIG. 23 and FIG. 24, in which there are text entry fields, show examples of how the information may be edited.

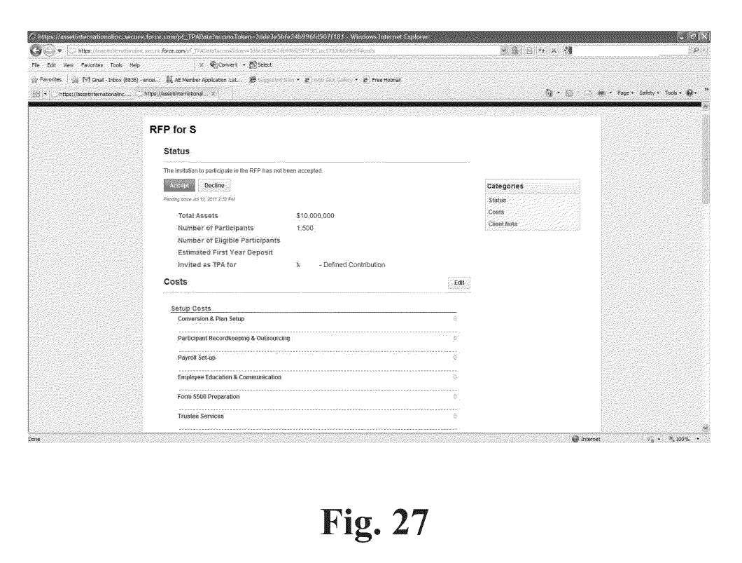

FIG. 27 is a screenshot of a user interface that would be presented to an investment provider in connection with a RFP, including the status of the invitation to participate in the RFP, and giving the investment provider the opportunity to accept or decline this invitation.

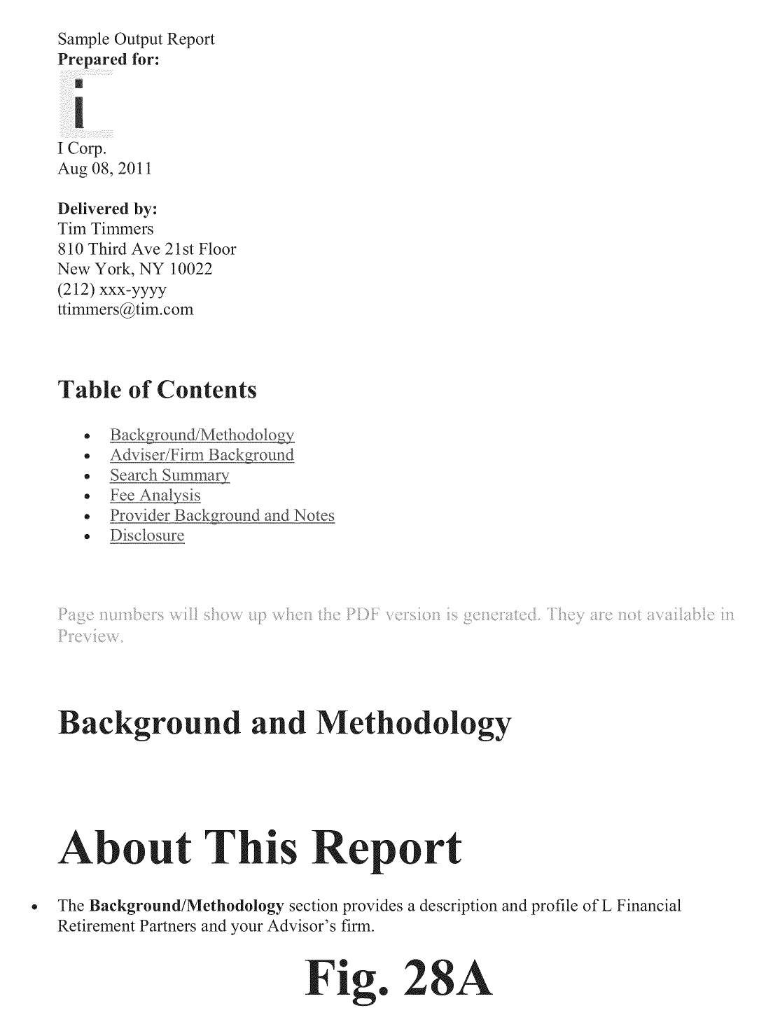

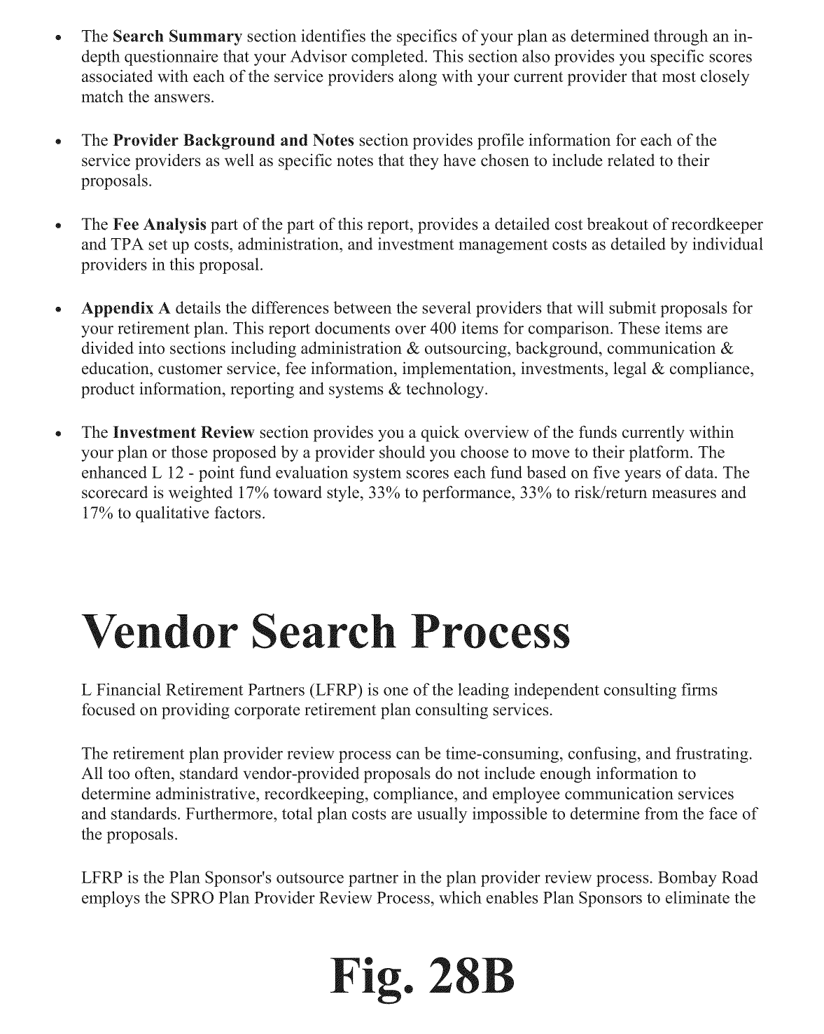

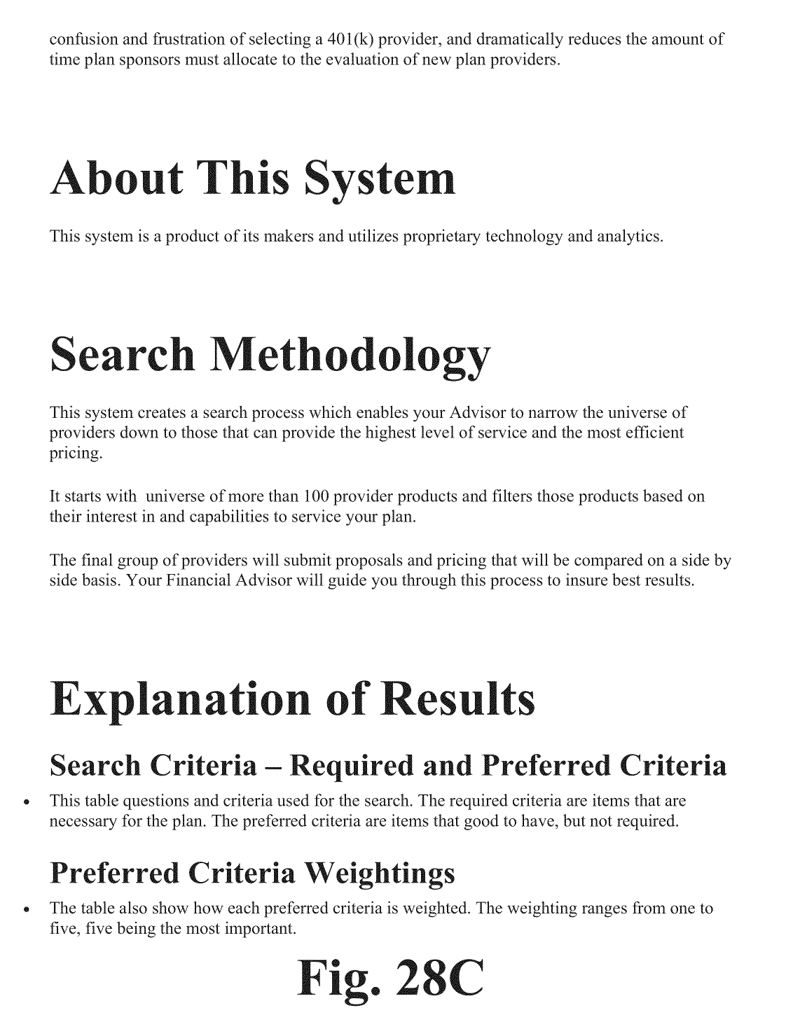

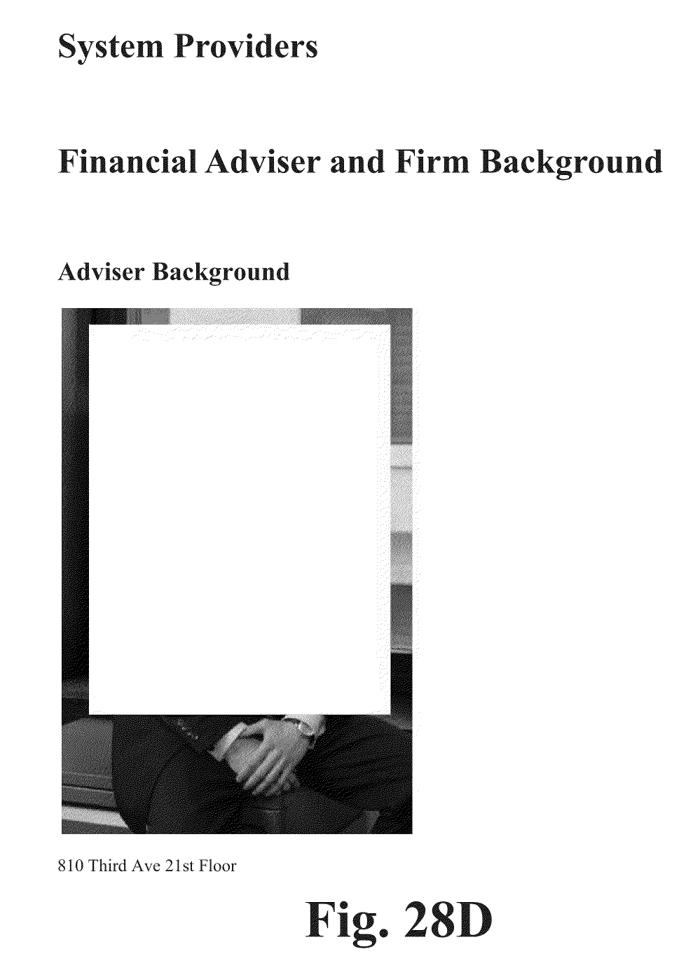

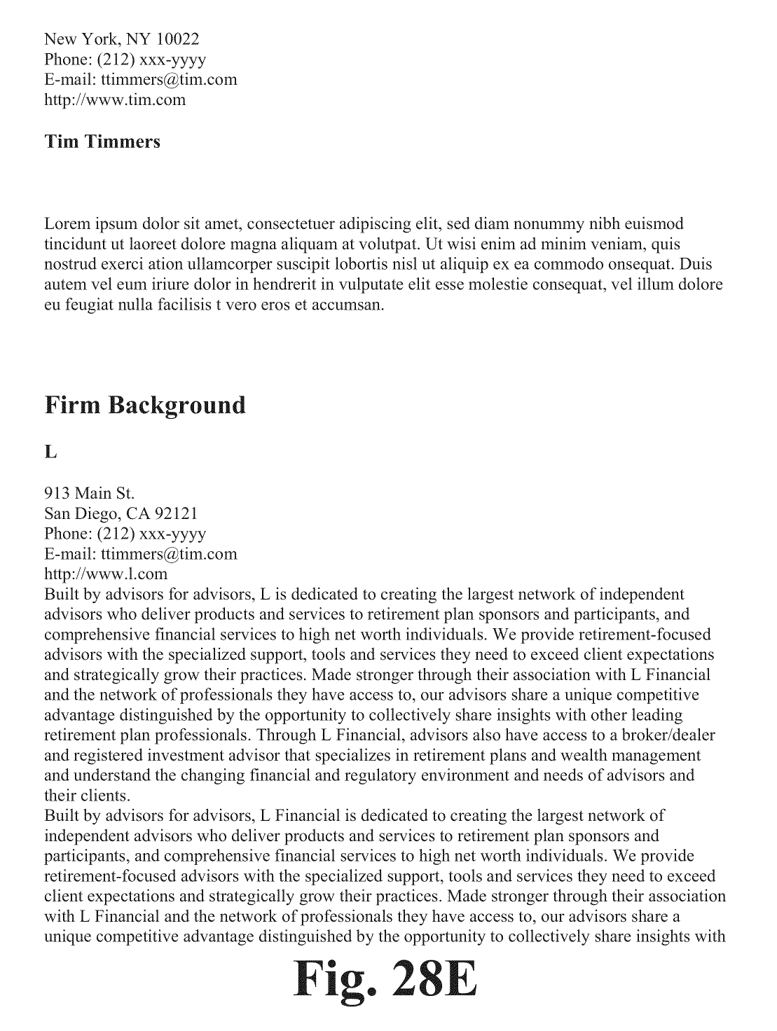

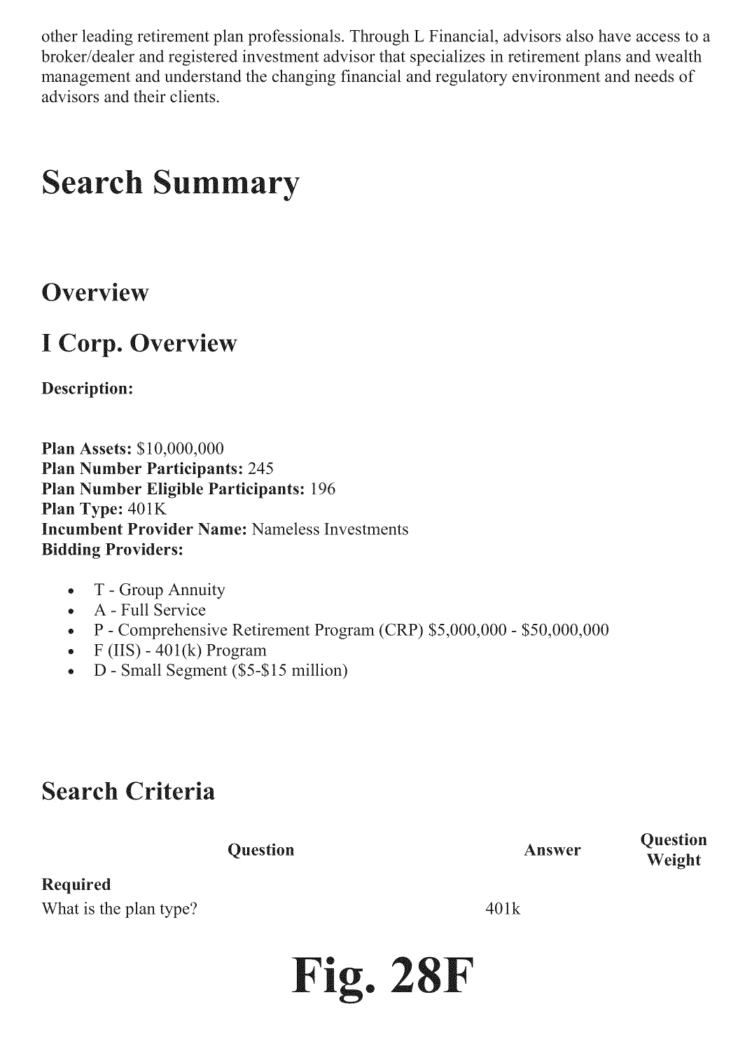

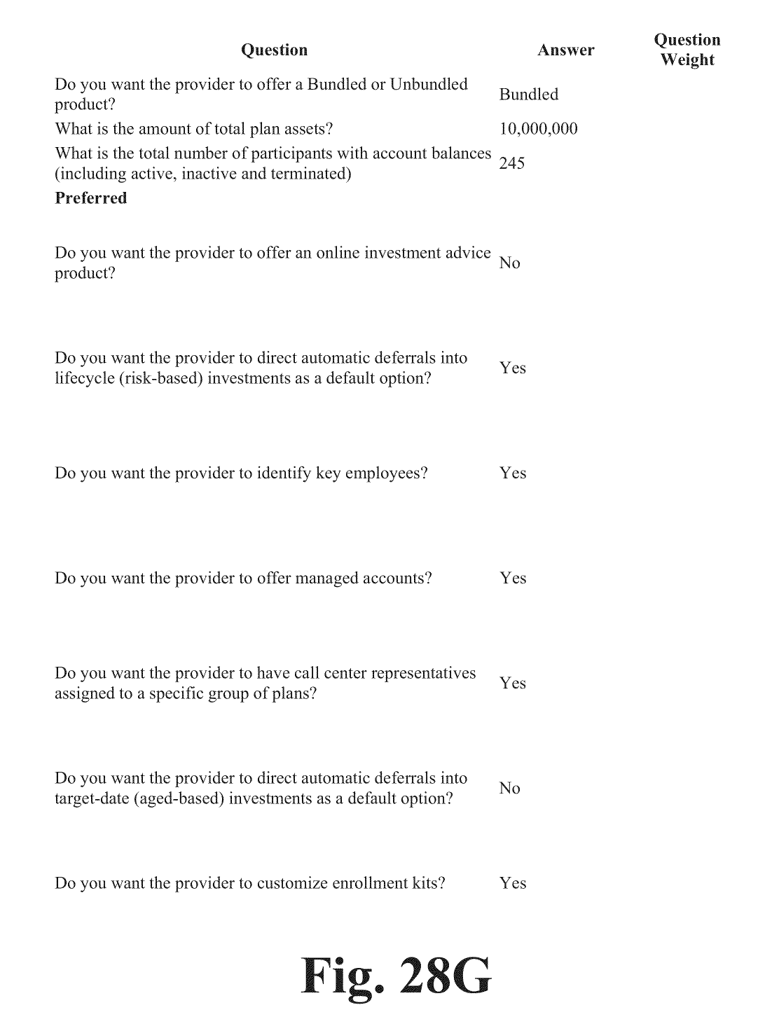

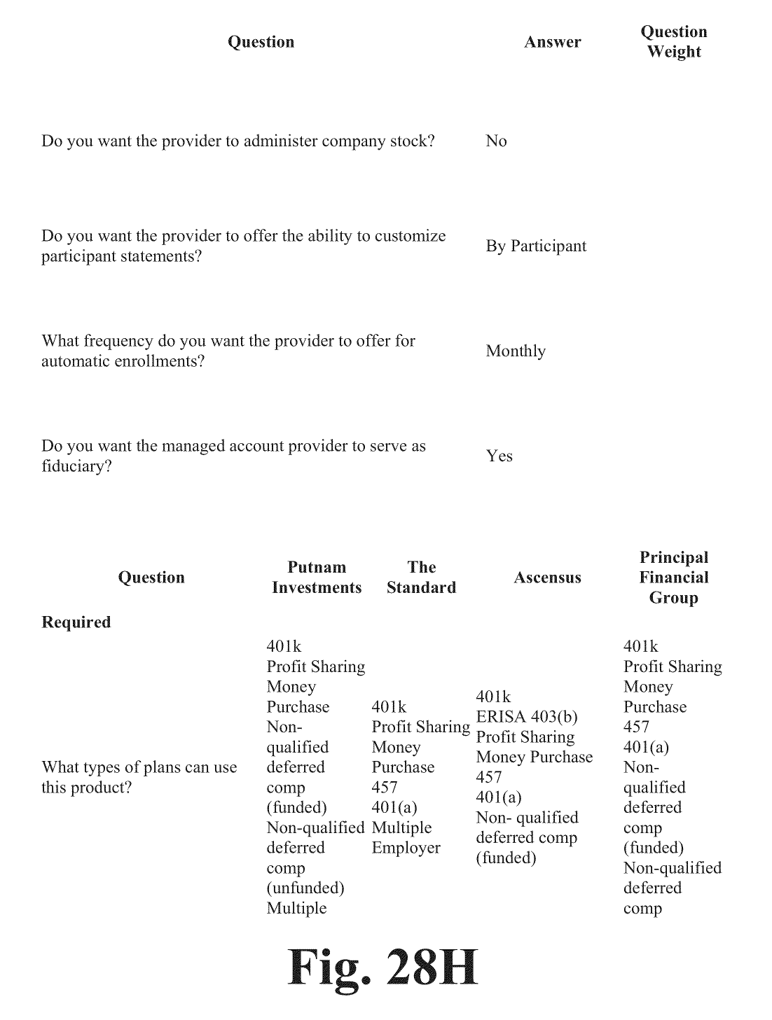

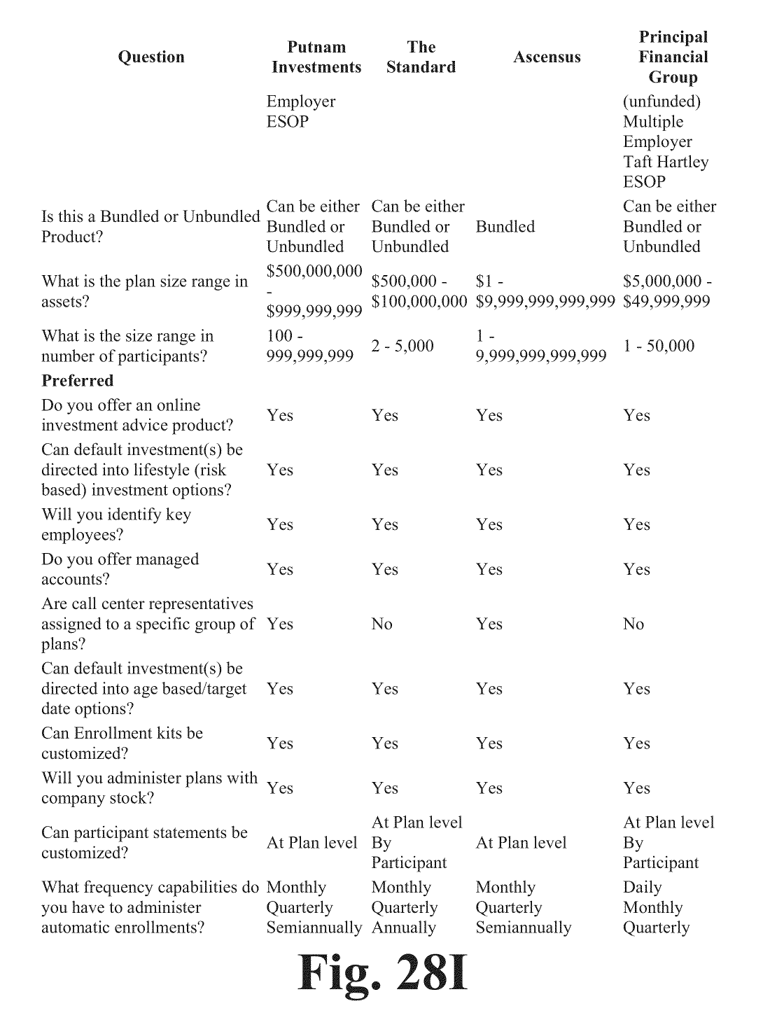

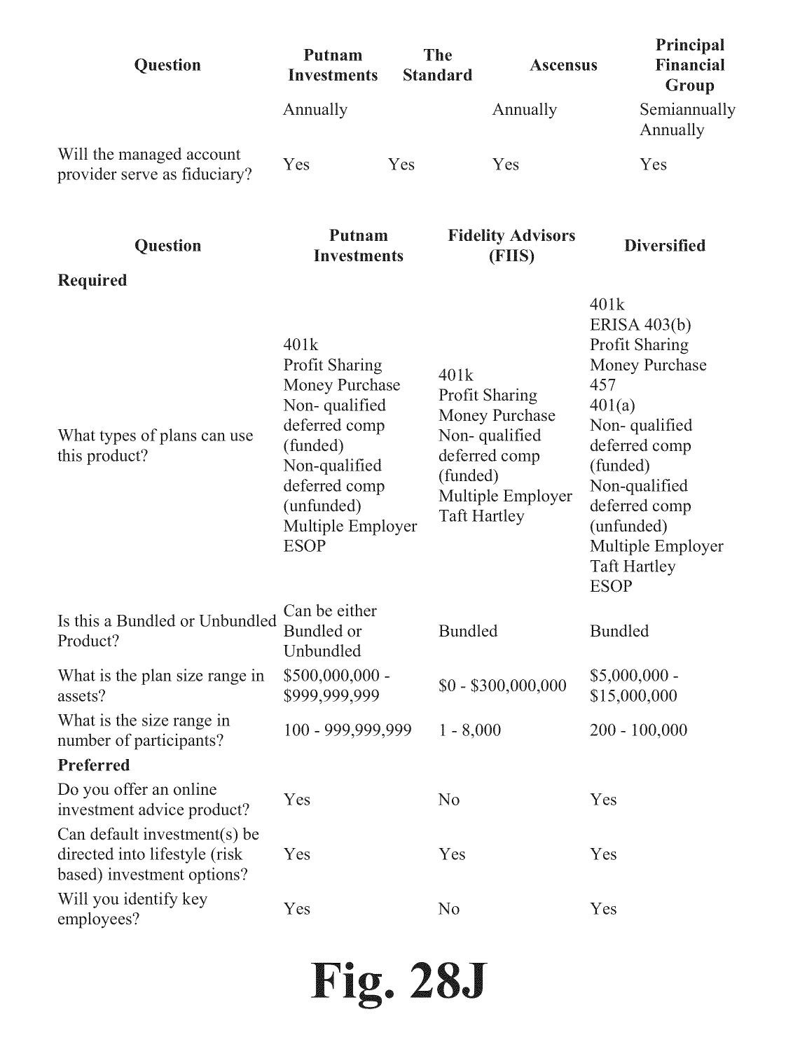

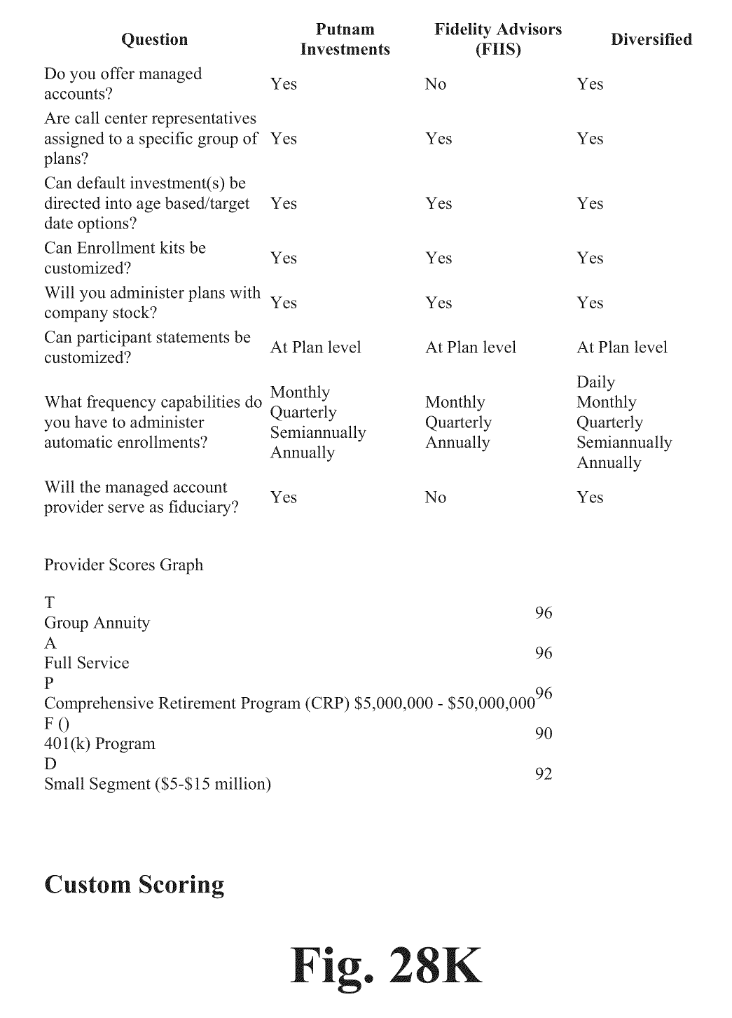

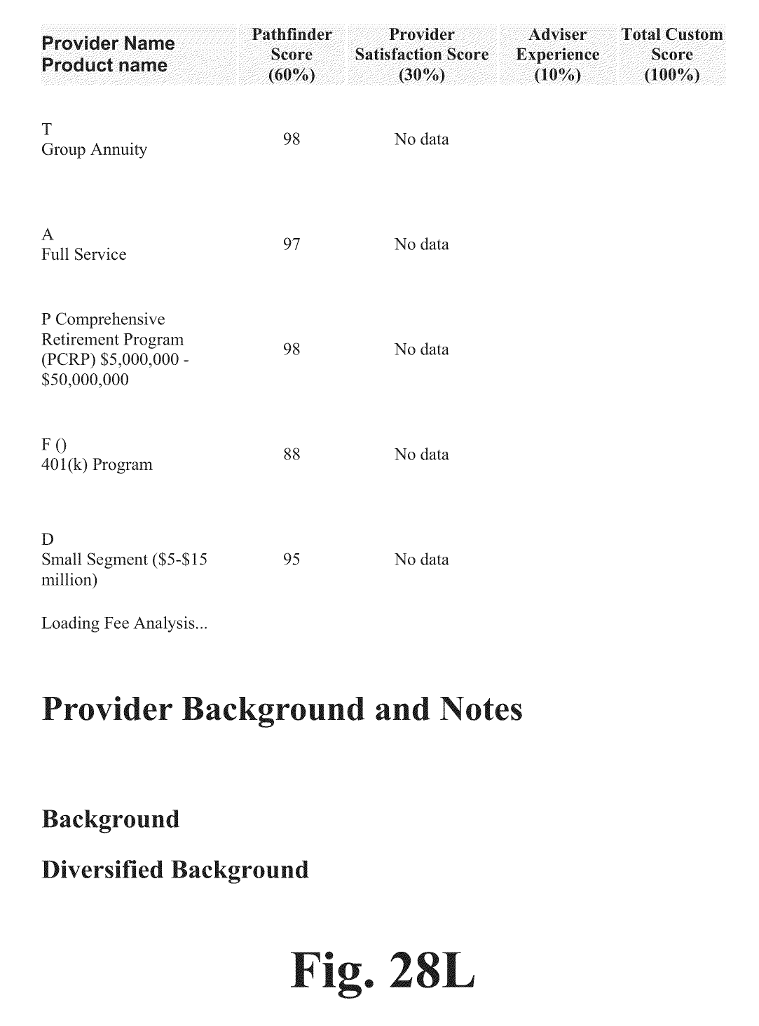

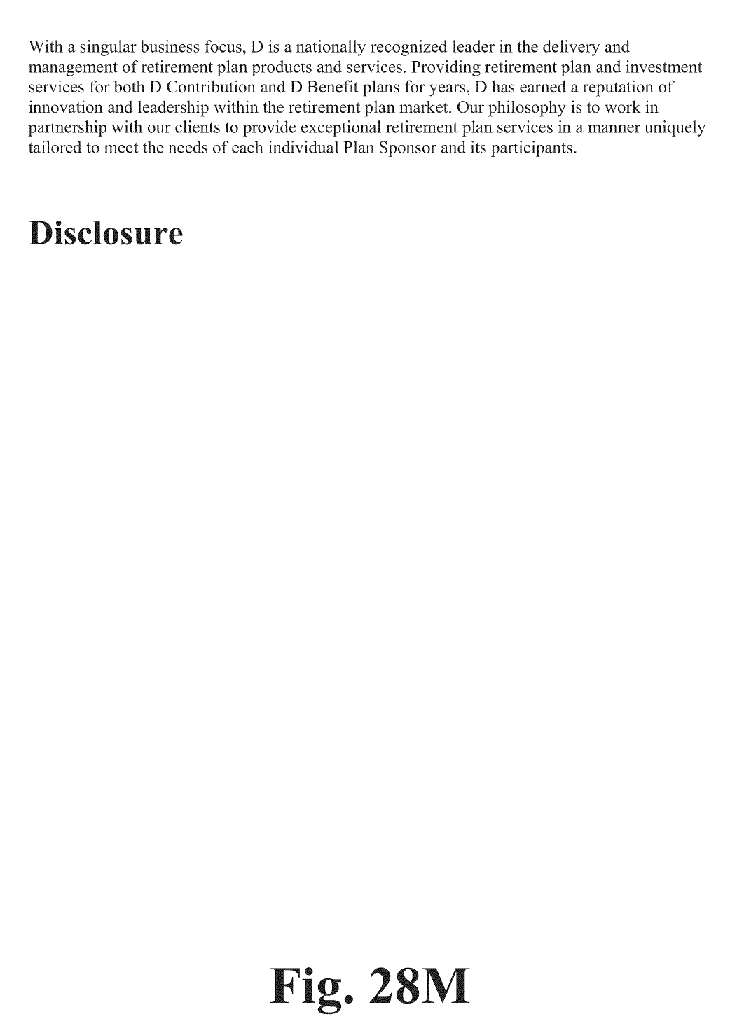

FIGS. 28A-M show various pages of a sample report generated according to one embodiment of the present invention, including various configurable sections that may be reordered, included, or not included, according to the preference of the investment advisor. An administrator may make some of these selections default and/or locked from modification by the investment advisor.

In one embodiment, a method for facilitating the evaluation of one or more financial products is provided, comprising the steps of:

providing a set of predetermined questions relating to a financial product;

allowing a user to electronically configure a set of required questions from the predetermined questions;

allowing the user to electronically configure appropriate answers for each question of the set of required questions;

allowing the user to electronically configure a set of preferred questions from the predetermined questions;

allowing the user to electronically configure appropriate answers for each question of the set of preferred questions;

allowing the user to electronically configure a weight for each question of the set of preferred questions;

allowing one or more providers of financial products to electronically provide responses to at least some of the questions of the set of required questions and at least some of the questions of the set of preferred questions;

electronically comparing the appropriate answers for each question of the set of required questions and the responses by the one or more providers of financial products to corresponding questions of the set of required questions;

electronically comparing the appropriate answers for each question of the set of preferred questions and the responses by the one or more providers of financial products to corresponding questions of the set of preferred questions;

electronically calculating a required question score for the one or more financial products based at least in part on a proportion of the questions of the set of required questions for which the corresponding appropriate answer matched the corresponding response;

electronically calculating a preferred question score for the one or more financial products based at least in part on the weights for the questions of the set of preferred questions and whether, for each question of the set of preferred questions, the corresponding appropriate answer matched the corresponding response;

electronically calculating a combined score for the one or more financial products based at least in part on a weighted average which is based on a weight of the required question score, a weight of the preferred question score, the required question score, and the preferred question score; and

electronically presenting the combined score for the one or more financial products to the user.

In a further embodiment, the weight of the required question score is in the range of 70%-75%.

An additional embodiment further comprises the step of allowing the user to electronically configure a weight for the required question score and a weight for the preferred question score to be used in the step of calculating the combined score.

Yet another additional embodiment further comprises the step of electronically setting a default weight of the required question score. The user may be given an option of electronically setting a new weight of the required question score to replace the default weight. The default weight may be in the range of 70%-75%.

In one more embodiment, the step of allowing the user to electronically configure a weight for each question of the set of preferred questions comprises allowing the user to electronically select, for each question of the set of preferred questions, an integer between one and five inclusive.

In another embodiment, the user may be precluded from configuring a weight for any of the questions of the set of required questions.

In an embodiment, when electronically presenting the combined score for the one or more financial products to the user, the combined score for the one or more financial products may be presented to the user in the form of a listing of the one or more financial products and their respective combined scores and a special visual symbol may be provided for those of the one or more financial products for which, for each question of the set of required questions, the corresponding response matches the corresponding appropriate answer. The special visual symbol may be an image.

In certain embodiments, an indication of whether the user is acting in a restricted role is electronically received and access is restricted to at least one electronic feature if the indication is that the user is acting in a restricted role. An identification of one or more financial products that are approved may also be electronically received, and the indication of whether the user is acting in a restricted role may be an indication of whether the user is not acting in a consulting capacity and the at least one electronic feature may comprise, when electronically presenting the combined score for the one or more financial products to the user, presenting results for financial products that are not approved. That is, results for financial products that are not approved may be filtered out when the user is indicated to be acting in a restricted role (e.g. not acting in a consulting capacity). Stated differently, those who are not acting in a consulting capacity may be acting in a restricted role.

In yet another additional embodiment, an identification of one or more financial products that are approved is electronically received. An indication of whether the user is acting in a consulting capacity may also be received, and, when electronically presenting the combined score for the one or more financial products to the user, results for financial products that are not approved may be filtered out if the indication is that the user is not acting in a consulting capacity. After electronically presenting the combined score for the one or more financial products to the user, the user may be allowed to electronically request generation of a RFP for one or more of the one or more financial products that are approved, and the one or more requested RFPs may be electronically generated and electronically transmitted to those of the one or more providers of financial products who provide the one or more of the one or more financial products that are approved. In a further embodiment, after electronically presenting the combined score for the one or more financial products to the user, the user is precluded from electronically requesting generation of a RFP for any of the financial products that are not approved.

In another embodiment, the method involves electronically presenting to the user, for the one or more financial products, the number of required questions for which the corresponding appropriate answer matches the corresponding response, the number of preferred questions for which the corresponding appropriate answer matches the corresponding response, the number of questions in the set of required questions, and the number of questions in the set of preferred questions.

In yet another embodiment, after electronically presenting the combined score for the one or more financial products to the user, the user is allowed to select a financial product for which the corresponding appropriate answer did not match the corresponding response for one or more of the questions of the set of required questions; and the user is electronically presented with, for the selected financial product, for each of the questions of the set of required questions for which the corresponding appropriate answer did not match the corresponding response, one or more of the question, the corresponding appropriate answer, and the corresponding response.

In one more embodiment after the user is electronically presented with the combined score for the one or more financial products, the user is allowed to select a financial product for which the corresponding appropriate answer did not match the corresponding response for one or more of the questions of the set of required questions, and the user is electronically presented with, for the selected financial product, for each of the questions of the set of required questions for which the corresponding appropriate answer did not match the corresponding response, the question, the corresponding appropriate answer, and the corresponding response.

In another embodiment, an electronic report is generated, including at least:
i) a set of reported questions comprising some of the questions of the set of required questions and/or some of the questions of the set of preferred questions;
ii) the appropriate answers for the questions of the set of reported questions;
iii) for at least one financial product, the responses for the questions of the set of reported questions; and
iv) for the at least one financial product, the combined score.

In yet another embodiment, an electronic report is generated, including at least one of:
i) a set of reported questions comprising some of the questions of the set of required questions and/or some of the questions of the set of preferred questions;
ii) the appropriate answers for the questions of the set of reported questions;
iii) for at least one financial product, the responses for the questions of the set of reported questions; or
iv) for the at least one financial product, the combined score.

In a further embodiment, the report also includes at least one comment from at least one of the user and a provider of financial products who provides at least one of the at least one financial product.

In another further embodiment, the user is allowed to electronically select the at least one financial product for which the responses for the questions of the set of reported questions and the combined score are included in the report.

In one more embodiment, the user is allowed to select sections from amongst a plurality of sections to be included in a report and a relative order in the report of the selected sections, and a report is electronically generated according to the user's selections.

In a further embodiment, the user is allowed to electronically assign a weight for the combined score and a weight for at least one additional factor, a total score is electronically calculated for the at least one financial product based at least in part on a weighted average of the combined score and the at least one additional factor, and when the report is electronically calculated, the total score is included in it. The at least one additional factor may comprise at least one of a score assigned to the provider of the financial product based on feedback from the provider's previous customers, a score assigned by the advisor based on the advisor's opinion, and a third party rating, such as a Good Housekeeping seal or a Moody's rating or any other rating well-known in the art.

In an embodiment, a method for facilitating the evaluation of one or more financial products is provided, comprising the steps of:

providing a set of predetermined questions relating a financial product;

allowing an individual other than a user to electronically pre-set a first set of questions from the predetermined questions.

allowing the user to electronically configure a set of required questions from the predetermined questions, while requiring the first set of questions to be included in the set of required questions;

allowing the user to electronically configure appropriate answers for each question of the set of required questions;

allowing the user to electronically configure a set of preferred questions from the predetermined questions;

allowing the user to electronically configure appropriate answers for each question of the set of preferred questions;

allowing the user to electronically configure a weight for each question of the set of preferred questions;

allowing one or more providers of financial products to electronically provide responses to at least some of the questions of the set of required questions and at least some of the questions of the set of preferred questions;

electronically comparing the appropriate answers for each question of the set of required questions and the responses by the one or more providers of financial products to corresponding questions of the set of required questions;

electronically comparing the appropriate answers for each question of the set of preferred questions and the responses by the one or more providers of financial products to corresponding questions of the set of preferred questions;

electronically calculating a required question score for the one or more financial products based at least in part on a proportion of the questions of the set of required questions for which the corresponding appropriate answer matched the corresponding response;

electronically calculating a preferred question score for the one or more financial products based at least in part on the weights for the questions of the set of preferred questions and whether, for each question of the set of preferred questions, the corresponding appropriate answer matched the corresponding response;

electronically calculating a combined score for the one or more financial products based at least in part on a weighted average of the required question score and the preferred question score; and

electronically presenting the combined score for the one or more financial products to the user.

In a further embodiment, the method also comprises the steps of:

allowing the individual other than the user to electronically pre-set a second set of questions from the predetermined questions; and

while allowing the user to electronically configure the set of preferred questions from the predetermined questions, requiring the second set of questions to be included in the set of preferred questions.

In another embodiment, a computerized system for facilitating the evaluation of one or more financial products is provided, comprising:

an electronic database containing a set of predetermined questions relating to a financial product;

configuration means for allowing a user to electronically configure a set of required questions from the predetermined questions, for allowing the user to electronically configure appropriate answers for each question of the set of required questions, for allowing the user to electronically configure a set of preferred questions from the predetermined questions, for allowing the user to electronically configure appropriate answers for each question of the set of preferred questions, and for allowing the user to electronically configure a weight for each question of the set of preferred questions.

communication means for allowing one or more providers of financial products to electronically provide responses to at least some of the questions of the set of required questions and at least some of the questions of the set of preferred questions;

a score calculating apparatus for electronically comparing the appropriate answers for each question of the set of required questions and the responses by the one or more providers of financial products to corresponding questions of the set of required questions, for electronically comparing the appropriate answers for each question of the set of preferred questions and the responses by the one or more providers of financial products to corresponding questions of the set of preferred questions, for electronically calculating a required question score for the one or more financial products based at least in part on a proportion of the questions of the set of required questions for which the corresponding appropriate answer matched the corresponding response, for electronically calculating a preferred question score for the one or more financial products based at least in part on the weights for the questions of the set of preferred questions and whether, for each question of the set of preferred questions, the corresponding appropriate answer matched the corresponding response, and for electronically calculating a combined score for the one or more financial products based at least in part on a weighted average which is based on a weight of the required question score, a weight of the preferred question score, the required question score, and the preferred question score; and

presentation means for electronically presenting the combined score for the one or more financial products to the user.

It will be understood that each of the steps in each of the present methods is preferably implemented on a digital computer and a computer network. While Applicants' invention has been particularly shown and described as referenced to the embodiments thereof, those skilled in the relevant art will understand that changes in form and detail may be made to these embodiments without departing from the spirit and scope of the invention. For example, although Applicants' invention has been particularly shown and described with reference to use in selecting a financial product, the present invention may also be used, by users including potential purchasers, in connection with products other than financial products, including, without limitation, consumer items or services such as cars or vacations, or specialized items or services such as custom-made equipment or construction services.

What is claimed is:

1. A method for facilitating the evaluation of one or more financial products, comprising the steps of:
providing a set of predetermined questions relating to a financial product;
allowing a user to electronically configure a set of required questions from the predetermined questions;
allowing the user to electronically configure appropriate answers for each question of the set of required questions;
allowing the user to electronically configure a set of preferred questions from the predetermined questions;
allowing the user to electronically configure appropriate answers for each question of the set of preferred questions;
allowing the user to electronically configure a weight for each question of the set of preferred questions;
allowing one or more providers of financial products to electronically provide responses to at least some of the questions of the set of required questions and at least some of the questions of the set of preferred questions;
electronically comparing the appropriate answers for each question of the set of required questions and the responses by the one or more providers of financial products to corresponding questions of the set of required questions;
electronically comparing the appropriate answers for each question of the set of preferred questions and the responses by the one or more providers of financial products to corresponding questions of the set of preferred questions;
electronically calculating a required question score for the one or more financial products based at least in part on a proportion of the questions of the set of required questions for which the corresponding appropriate answer matched the corresponding response;
electronically calculating a preferred question score for the one or more financial products based at least in part on the weights for the questions of the set of preferred questions and whether, for each question of the set of preferred questions, the corresponding appropriate answer matched the corresponding response;
electronically calculating a combined score for the one or more financial products based at least in part on a weighted average which is based on a weight of the required question score, a weight of the preferred question score, the required question score, and the preferred question score; and
electronically presenting the combined score for the one or more financial products to the user.

2. The method of claim 1, wherein the weight of the required question score is in the range of 70%-75%.

3. The method of claim 1, further comprising the step of:
allowing the user to electronically configure a weight for the required question score and a weight for the preferred question score to be used in the step of calculating the combined score.

4. The method of claim 1, further comprising the step of:
electronically setting a default weight of the required question score.

5. The method of claim 4, further comprising the step of:
giving the user an option of electronically setting a new weight of the required question score to replace the default weight.

6. The method of claim 4, wherein the default weight is in the range of 70%-75%.

7. The method of claim 1, wherein the step of allowing the user to electronically configure a weight for each question of the set of preferred questions comprises allowing the user to electronically select, for each question of the set of preferred questions, an integer between one and five inclusive.

8. The method of claim 1, further comprising the step of:
precluding the user from configuring a weight for any of the questions of the set of required questions.

9. The method of claim 1, further comprising the steps of:
when electronically presenting the combined score for the one or more financial products to the user, presenting the combined score for the one or more financial products to the user in the form of a listing of the one or more financial products and their respective combined scores; and
providing a special visual symbol for those of the one or more financial products for which, for each question of the set of required questions, the corresponding response matches the corresponding appropriate answer.

10. The method of claim 9, wherein the special visual symbol is an image.

11. The method of claim 1, further comprising the step of:
electronically receiving an identification of one or more financial products that are approved.

12. The method of claim 1, further comprising the steps of:
electronically receiving an indication of whether the user is acting in a restricted role; and
restricting access to at least one electronic feature if the indication is that the user is acting in a restricted role.

13. The method of claim 11, further comprising the steps of:
electronically receiving an indication of whether the user is acting in a consulting capacity; and
when electronically presenting the combined score for the one or more financial products to the user, filtering out results for financial products that are not approved if the indication is that the user is not acting in a consulting capacity.

14. The method of claim 11, further comprising the steps of:
after electronically presenting the combined score for the one or more financial products to the user, allowing the user to electronically request generation of a RFP for one or more of the one or more financial products that are approved;
electronically generating the one or more requested RFPs; and
electronically transmitting the one or more requested RFPs to those of the one or more providers of financial products who provide the one or more of the one or more financial products that are approved.

15. The method of claim 14, further comprising the step of:
after electronically presenting the combined score for the one or more financial products to the user, precluding the user from electronically requesting generation of a RFP for any of the financial products that are not approved.

16. The method of claim 1, further comprising the step of:
electronically presenting to the user, for the one or more financial products, the number of required questions for which the corresponding appropriate answer matches the corresponding response, the number of preferred questions for which the corresponding appropriate answer matches the corresponding response, the number of questions in the set of required questions, and the number of questions in the set of preferred questions.

17. The method of claim 1, further comprising the steps of:
after electronically presenting the combined score for the one or more financial products to the user, allowing the user to select a financial product for which the corresponding appropriate answer did not match the corresponding response for one or more of the questions of the set of required questions; and
electronically presenting to the user, for the selected financial product, for each of the questions of the set of required questions for which the corresponding appropriate answer did not match the corresponding response, one or more of the question, the corresponding appropriate answer, and the corresponding response.

18. The method of claim 1, further comprising the steps of:
after electronically presenting the combined score for the one or more financial products to the user, allowing the user to select a financial product for which the corresponding appropriate answer did not match the corresponding response for one or more of the questions of the set of required questions; and
electronically presenting to the user, for the selected financial product, for each of the questions of the set of required questions for which the corresponding appropriate answer did not match the corresponding response, the question, the corresponding appropriate answer, and the corresponding response.

19. The method of claim 1, further comprising the step of:
electronically generating a report including at least:
v) a set of reported questions comprising some of the questions of the set of required questions and/or some of the questions of the set of preferred questions;
vi) the appropriate answers for the questions of the set of reported questions;
vii) for at least one financial product, the responses for the questions of the set of reported questions; and
viii) for the at least one financial product, the combined score.

20. The method of claim 1, further comprising the step of:
electronically generating a report including at least one of:
v) a set of reported questions comprising some of the questions of the set of required questions and/or some of the questions of the set of preferred questions;
vi) the appropriate answers for the questions of the set of reported questions;
vii) for at least one financial product, the responses for the questions of the set of reported questions; or
viii) for the at least one financial product, the combined score.

21. The method of claim 19, wherein the report also includes at least one comment from at least one of the user and a provider of financial products who provides at least one of the at least one financial product.

22. The method of claim 19, further comprising the step of:
allowing the user to electronically select the at least one financial product for which the responses for the questions of the set of reported questions and the combined score are included in the report.

23. The method of claim 1, further comprising the step of:
allowing the user to select sections from amongst a plurality of sections to be included in a report and a relative order in the report of the selected sections; and
electronically generating the report according to the user's selections.

24. The method of claim 19, further comprising the steps of:
allowing the user to electronically assign a weight for the combined score and a weight for at least one additional factor;
electronically calculating a total score for the at least one financial product based at least in part on a weighted average of the combined score and the at least one additional factor; and
when electronically generating the report, including the total score.

25. The method of claim 24, wherein the at least one additional factor comprises at least one of a score assigned to the provider of the financial product based on feedback from the provider's previous customers, a score assigned by the advisor based on the advisor's opinion, and a third party rating.

26. A method for facilitating the evaluation of one or more financial products, comprising the steps of:
providing a set of predetermined questions relating a financial product;
allowing an individual other than a user to electronically pre-set a first set of questions from the predetermined questions.
allowing the user to electronically configure a set of required questions from the predetermined questions, while requiring the first set of questions to be included in the set of required questions;
allowing the user to electronically configure appropriate answers for each question of the set of required questions;
allowing the user to electronically configure a set of preferred questions from the predetermined questions;
allowing the user to electronically configure appropriate answers for each question of the set of preferred questions;
allowing the user to electronically configure a weight for each question of the set of preferred questions;
allowing one or more providers of financial products to electronically provide responses to at least some of the questions of the set of required questions and at least some of the questions of the set of preferred questions;
electronically comparing the appropriate answers for each question of the set of required questions and the responses by the one or more providers of financial products to corresponding questions of the set of required questions;
electronically comparing the appropriate answers for each question of the set of preferred questions and the responses by the one or more providers of financial products to corresponding questions of the set of preferred questions;
electronically calculating a required question score for the one or more financial products based at least in part on a proportion of the questions of the set of required questions for which the corresponding appropriate answer matched the corresponding response;
electronically calculating a preferred question score for the one or more financial products based at least in part on the weights for the questions of the set of preferred questions and whether, for each question of the set of preferred questions, the corresponding appropriate answer matched the corresponding response;
electronically calculating a combined score for the one or more financial products based at least in part on a weighted average of the required question score and the preferred question score; and
electronically presenting the combined score for the one or more financial products to the user.

27. The method of claim 26, further comprising the steps of:
allowing the individual other than the user to electronically pre-set a second set of questions from the predetermined questions; and
while allowing the user to electronically configure the set of preferred questions from the predetermined questions, requiring the second set of questions to be included in the set of preferred questions.

28. A computerized system for facilitating the evaluation of one or more financial products, comprising:
an electronic database containing a set of predetermined questions relating to a financial product;
configuration means for allowing a user to electronically configure a set of required questions from the predetermined questions, for allowing the user to electronically configure appropriate answers for each question of the set of required questions, for allowing the user to electronically configure a set of preferred questions from the predetermined questions, for allowing the user to electronically configure appropriate answers for each question of the set of preferred questions, and for allowing the user to electronically configure a weight for each question of the set of preferred questions.
communication means for allowing one or more providers of financial products to electronically provide responses to at least some of the questions of the set of required questions and at least some of the questions of the set of preferred questions;
a score calculating apparatus for electronically comparing the appropriate answers for each question of the set of required questions and the responses by the one or more providers of financial products to corresponding questions of the set of required questions, for electronically comparing the appropriate answers for each question of the set of preferred questions and the responses by the one or more providers of financial products to corresponding questions of the set of preferred questions, for electronically calculating a required question score for the one or more financial products based at least in part on a proportion of the questions of the set of required questions for which the corresponding appropriate answer matched the corresponding response, for electronically calculating a preferred question score for the one or more financial products based at least in part on the weights for the questions of the set of preferred questions and whether, for each question of the set of preferred questions, the corresponding appropriate answer matched the corresponding response, and for electronically calculating a combined score for the one or more financial products based at least in part on a weighted average which is based on a weight of the required question score, a weight of the preferred question score, the required question score, and the preferred question score; and
presentation means for electronically presenting the combined score for the one or more financial products to the user.

29. A method for facilitating the evaluation of one or more products by a potential purchaser, comprising the steps of:
providing a set of predetermined questions relating to a product;
allowing a potential purchaser to electronically configure a set of required questions from the predetermined questions;
allowing the potential purchaser to electronically configure appropriate answers for each question of the set of required questions;
allowing the potential purchaser to electronically configure a set of preferred questions from the predetermined questions;
allowing the potential purchaser to electronically configure appropriate answers for each question of the set of preferred questions;
allowing the potential purchaser to electronically configure a weight for each question of the set of preferred questions;
allowing one or more product providers to electronically provide responses to at least some of the questions of the set of required questions and at least some of the questions of the set of preferred questions;
electronically comparing the appropriate answers for each question of the set of required questions and the responses by the one or more product providers to corresponding questions of the set of required questions;
electronically comparing the appropriate answers for each question of the set of preferred questions and the responses by the one or more product providers to corresponding questions of the set of preferred questions;
electronically calculating a required question score for the one or more products based at least in part on a proportion of the questions of the set of required questions for which the corresponding appropriate answer matched the corresponding response;
electronically calculating a preferred question score for the one or more products based at least in part on the weights for the questions of the set of preferred questions and whether, for each question of the set of preferred questions, the corresponding appropriate answer matched the corresponding response;
electronically calculating a combined score for the one or more products based at least in part on a weighted average which is based on a weight of the required question score, a weight of the preferred question score, the required question score, and the preferred question score; and
electronically presenting the combined score for the one or more products to the potential purchaser.
